(19) United States
(12) Patent Application Publication
(10) Pub. No.: US 2026/0235761 A1
(43) Pub. Date: Aug. 13, 2026

(54) SYSTEMS AND METHODS FOR DETERMINING ADJACENT RAILROAD TRACKS USING LIDAR

(71) Applicant: BNSF Railway Company, Fort Worth, TX (US)

(72) Inventors: Michael S. Saniei, Fort Worth, TX (US); Ranjan Dash, Flower Mound, TX (US); Yasha Hajizeinalibiouki, Plano, TX (US)

(73) Assignee: BNSF Railway Company, Fort Worth, TX (US)

(21) Appl. No.: 19/051,862

(22) Filed: Feb. 12, 2025

Related U.S. Application Data
(63) Continuation-in-part of application No. 19/051,517, filed on Feb. 12, 2025.

(51) Int. Cl. G01S 17/89; G01S 17/08; G01S 17/86; G01S 17/931

(52) U.S. Cl. CPC G01S 17/89; G01S 17/08; G01S 17/86; G01S 17/931

(57) ABSTRACT

A method for determining adjacent railroad tracks in a railroad track environment using light detection and ranging (LiDAR) includes accessing LiDAR point cloud data stored in one or more memory units. The method further includes identifying, by analyzing the LiDAR point cloud data, one or more adjacent railroad tracks within the railroad track environment. Each adjacent railroad track is adjacent to a subject railroad track. The method further includes determining, from a plurality of adjacent railroad track types, an adjacent railroad track type for each of the identified adjacent railroad tracks. The method further includes displaying a graphical user interface on an electronic display. The graphical user interface permits user review of the identified adjacent railroad tracks. The graphical user displays the determined adjacent railroad track type for each particular identified adjacent railroad track and one or more images of the particular adjacent railroad track.

### CROSS-REFERENCE TO RELATED APPLICATIONS

The present application is a continuation-in-part of pending and co-owned U.S. patent application Ser. No. 19/051,517, entitled “SYSTEMS AND METHODS FOR IDENTIFYING RAILROAD TRACK RAILS AND DETERMINING RAILROAD TRACK CHARACTERISTICS USING LIDAR, filed Feb. 12, 2025, the entirety of which is herein incorporated by reference for all purposes.

### TECHNICAL FIELD

The present disclosure relates generally to Light Detection and Ranging (LiDAR), and more particularly to systems and methods for determining adjacent railroad tracks using LiDAR.

### BACKGROUND

In railroad transportation systems, railroad tracks are located in environments that include many different types of physical objects that are in close proximity to the railroad tracks. For example, milepost markers, overhead wires (e.g., electrical and communication wires), posts, signs, and signals are typically physically placed in close proximity to railroad tracks. As another example, railroad tracks often pass across bridges and through tunnels which include support structures (e.g., bridge supports and tunnel walls and ceilings) that are in close proximity to the railroad tracks. As yet another example, adjacent railroad tracks may be occupied by railcars that are in close proximity to the railroad track.

Most railroad cars and their loads are physically limited to a predetermined size in order to avoid contacting physical objects that are located in close proximity to the railroad tracks. As a specific example, standard railroad cars and their loads may be limited to be a maximum of eleven feet wide and a maximum of seventeen feet tall from the top of the rails of the railroad track. Railroad cars and loads that exceed these dimensions are known as oversized loads. Railroad operators must take special care when transporting oversized loads on railroad tracks in order to avoid contacting physical objects such as signs, tunnel walls, bridge supports, and railcars on adjacent tracks that are located in close proximity to the railroad tracks.

### SUMMARY

The present disclosure achieves technical advantages as systems, methods, and computer-readable storage media for determining adjacent railroad tracks using Light Detection and Ranging (LiDAR). The functionality for determining adjacent railroad tracks is based at least in part on an analysis of LiDAR point cloud data using one or more deep-learning models such as POINTNET. The determined adjacent railroad tracks may be used to provide clearance to a train carrying an oversized load. The LiDAR point cloud data is captured by one or more LiDAR instruments that are attached to a rail vehicle as the rail vehicle traverses the railroad track.

In embodiments, the present disclosure provides for a system integrated into a practical application with meaningful limitations as systems, methods, and computer-readable storage media for automatically determining adjacent railroad tracks using LiDAR point data for transportation systems such as railroads. In embodiments, a railroad oversized load clearance system may be configured to capture LiDAR point cloud data using one or more LiDAR instruments. The railroad oversized load clearance system may be further configured to identify, by analyzing the LiDAR point cloud data, one or more adjacent railroad tracks within a railroad track environment, determine, from a plurality of adjacent railroad track types, an adjacent railroad track type for each of the identified adjacent railroad tracks, and display a graphical user interface on an electronic display that permits user review of the identified adjacent railroad tracks.

A technical improvement of the features provided herein includes automatically determining adjacent railroad tracks using LiDAR point data for transportation systems such as railroads. This adjacent railroad track determination process contributes to the overall efficiency of the railroad operations by streamlining oversized load clearance operations. In addition, the system of embodiments can generate alerts and notifications to personnel in order to view adjacent railroad tracks for a particular segment of railroad track.

Collectively, these technical improvements provided by embodiments of the present disclosure contribute to a more safe, efficient, and reliable railroad operation, capable of handling the complexities of modern freight transportation.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for determining adjacent railroad tracks for oversized load clearance operations. In doing so, the present disclosure goes well beyond a mere application the manual process to a computer. Accordingly, the disclosure and/or claims herein necessarily provide a technological solution that overcomes a technological problem.

Furthermore, the functionality for automatically determining adjacent railroad tracks for oversized load clearance operations that is provided by the present disclosure represents a specific and particular implementation that results in an improvement in the utilization of a computing system for resource optimization. Thus, rather than a mere improvement that comes about from using a computing system, the present disclosure, in enabling a system to leverage functionality for determining adjacent railroad tracks to optimize oversized load clearance operations, represents features that result in a computing system device that can be used more efficiently and is improved over current systems that do not implement the functionality described herein. As such, the present disclosure and/or claims are directed to patent eligible subject matter.

In embodiments, the present disclosure includes techniques for training models (e.g., machine-learning models, artificial intelligence models, algorithmic constructs, etc.) for performing or executing a designated task or a series of tasks (e.g., one or more features for automatically determining adjacent railroad tracks in accordance with embodiments of the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical applications that significantly enhance the functionality, reliability, and efficiency of the models developed through these processes.

In embodiments, the present disclosure includes techniques for generating a notification of an event (e.g., an identification of adjacent railroad tracks, etc.) includes generating an alert that includes information specifying the location of a source of data associated with the event, formatting the alert into data structured according to an information format; and transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of automatically determining adjacent railroad tracks using LiDAR point cloud data. It is a further object of the disclosure to provide a system for automatically determining adjacent railroad tracks using LiDAR point cloud data, and a computer-based tool for automatically determining adjacent railroad tracks using LiDAR point cloud data. These and other objects are provided by the present disclosure, including at least the following embodiments.

In one particular embodiment, a system for determining adjacent railroad tracks in a railroad track environment using LiDAR is provided. The system includes one or more LiDAR instruments configured to capture LiDAR point cloud data that indicates locations of objects and surfaces within the railroad track environment. The system further includes one or more memory units configured to store the LiDAR point cloud data. The system further includes one or more computer processors communicatively coupled to the one or more memory units and configured to access the LiDAR point cloud data stored in the one or more memory units. The one or more computer processors are further configured to determine, by analyzing the LiDAR point cloud data, a subject railroad track within the railroad track environment. The one or more computer processors are further configured to identify, by analyzing the LiDAR point cloud data, one or more adjacent railroad tracks within the railroad track environment. Each adjacent railroad track is adjacent to the subject railroad track. The one or more computer processors are further configured to determine, from a plurality of adjacent railroad track types, an adjacent railroad track type for each of the identified adjacent railroad tracks. The one or more computer processors are further configured to display a graphical user interface on an electronic display. The graphical user interface is configured to permit user review of the identified adjacent railroad tracks. The graphical user interface is further configured to display, for each particular identified adjacent railroad track: the determined adjacent railroad track type for the particular identified adjacent railroad track; and one or more images of the particular adjacent railroad track.

In another embodiment, a method of determining adjacent railroad tracks in a railroad track environment using LiDAR is provided. The method includes accessing LiDAR point cloud data stored in one or more memory units. The LiDAR point cloud data includes locations of objects and surfaces within the railroad track environment. The method further includes determining, by analyzing the LiDAR point cloud data, a subject railroad track within the railroad track environment. The method further includes identifying, by analyzing the LiDAR point cloud data, one or more adjacent railroad tracks within the railroad track environment. Each adjacent railroad track is adjacent to the subject railroad track. The method further includes determining, from a plurality of adjacent railroad track types, an adjacent railroad track type for each of the identified adjacent railroad tracks. The method further includes displaying a graphical user interface on an electronic display. The graphical user interface is configured to permit user review of the identified adjacent railroad tracks. The graphical user interface is further configured to display for each particular identified adjacent railroad track: the determined adjacent railroad track type for the particular identified adjacent railroad track; and one or more images of the particular identified adjacent railroad track.

In yet another embodiment, one or more computer-readable non-transitory storage media embodying instructions is provided. When executed by a processor, the instructions cause the processor to perform operations including accessing light detection and ranging (LiDAR) point cloud data stored in one or more memory units. The LiDAR point cloud data includes locations of objects and surfaces within a railroad track environment. The operations further include identifying, by analyzing the LiDAR point cloud data, one or more adjacent railroad tracks within the railroad track environment. Each adjacent railroad track is adjacent to a subject railroad track. The operations further include determining, from a plurality of adjacent railroad track types, an adjacent railroad track type for each of the identified adjacent railroad tracks. The operations further include displaying a graphical user interface on an electronic display. The graphical user interface is configured to permit user review of the identified adjacent railroad tracks. The graphical user interface is further configured to display for each particular identified adjacent railroad track: the determined adjacent railroad track type for the particular identified adjacent railroad track; and one or more images of the particular identified adjacent railroad track.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a railroad oversized load clearance system, according to particular embodiments.

FIG. 2A illustrates LiDAR point cloud data that may be captured and used by the railroad oversized load clearance system of FIG. 1, according to particular embodiments.

FIG. 2B illustrates a 360-degree camera image that may be captured and used by the railroad oversized load clearance system of FIG. 1, according to particular embodiments.

FIG. 3 illustrates a rail identification module that may be utilized by the railroad oversized load clearance system of FIG. 1, according to particular embodiments.

FIG. 4A illustrates rails and a track centerline that have been identified by the rail identification module of FIG. 3, according to particular embodiments.

FIG. 4B illustrates a top-of-rails position that has been identified by the rail identification module of FIG. 3, according to particular embodiments.

FIG. 5 illustrates the calculation of a curvature of a railroad track by the rail identification module of FIG. 3, according to particular embodiments.

FIG. 6 illustrates the calculation of a cross-level of a railroad track by the rail identification module of FIG. 3, according to particular embodiments.

FIG. 7 illustrates a railroad obstruction detection module that may be utilized by the railroad oversized load clearance system of FIG. 1, according to particular embodiments.

FIGS. 8A and 8B illustrate a clearance envelope that may be determined by the railroad obstruction detection module of FIG. 7, according to particular embodiments.

FIG. 8C illustrates a raw obstruction within a clearance envelope that may be determined by the railroad obstruction detection module of FIG. 7, according to particular embodiments.

FIGS. 9A-9F illustrate various types of a raw obstructions that may be determined by the railroad obstruction detection module of FIG. 7, according to particular embodiments.

FIG. 10 is a chart illustrating a method for determining obstruction types that may be utilized by the railroad obstruction detection module of FIG. 7, according to particular embodiments.

FIG. 11A illustrates a cropped point cloud image that may be generated by the railroad obstruction detection module of FIG. 7, according to particular embodiments.

FIG. 11B illustrates a cropped 360-degree image that may be generated by the railroad obstruction detection module of FIG. 7, according to particular embodiments.

FIGS. 12-13 illustrate graphical user interfaces that permit user review of obstructions identified by the railroad obstruction detection module of FIG. 7, according to particular embodiments.

FIG. 14 is a chart illustrating a method for determining obstructions in a railroad track environment, according to particular embodiments.

FIG. 15 illustrates a railroad adjacent track detection module that may be utilized by the railroad oversized load clearance system of FIG. 1, according to particular embodiments.

FIG. 16A illustrates adjacent railroad tracks that have been identified by the railroad adjacent track detection module of FIG. 15, according to particular embodiments.

FIGS. 16B-16C illustrate cross sections of LiDAR point cloud data that may be analyzed by the railroad adjacent track detection module of FIG. 15 in order to detect adjacent railroad tracks, according to particular embodiments.

FIG. 16D illustrates a graphical user interface that displays information about adjacent railroad tracks determined by the railroad adjacent track detection module of FIG. 15, according to particular embodiments.

FIG. 16E illustrates a cropped point cloud image that may be generated by the railroad adjacent track detection module of FIG. 15, according to particular embodiments.

FIG. 16F illustrates a cropped 360-degree image that may be generated by the railroad adjacent track detection module of FIG. 15, according to particular embodiments.

FIG. 17 illustrates a graphical user interface that permits user review of adjacent tracks identified by the railroad adjacent track detection module of FIG. 15, according to particular embodiments.

FIG. 18 is a chart illustrating a method for determining adjacent railroad tracks in a railroad track environment, according to particular embodiments.

FIG. 19 is an example computer system that can be utilized to implement aspects of the various technologies presented herein, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive, may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

In railroad transportation systems, railroad tracks are located in environments that include many different types of physical objects that are in close proximity to the railroad tracks. For example, milepost markers, overhead wires (e.g., electrical and communication wires), posts, signs, and signals are typically physically placed in close proximity to railroad tracks. As another example, railroad tracks often pass across bridges and through tunnels which include support structures (e.g., bridge supports and tunnel walls and ceilings) that are in close proximity to the railroad tracks. As yet another example, adjacent railroad tracks may be occupied by railcars that are in close proximity to the railroad track.

Most railroad cars and their loads are physically limited to a predetermined size in order to avoid contacting physical objects that are located in close proximity to the railroad tracks. As a specific example, standard railroad cars and their loads may be limited to be a maximum of eleven feet wide and a maximum of seventeen feet tall from the top of the rails of the railroad track. Railroad cars and loads that exceed these dimensions are known as oversized loads. Railroad operators must take special care when transporting oversized loads on railroad tracks in order to avoid contacting physical objects such as signs, tunnel walls, bridge supports, and railcars on adjacent tracks that are located in close proximity to the railroad tracks.

Railroad operators typically keep records of objects such as signs, tunnel walls, and bridge supports that are located in close proximity to the railroad tracks and may use the information to provide clearance for a train carrying an oversized load. For example, a railroad operator may utilize crews to physically measure and record distances from the railroad track to objects such as signs and tunnel walls. Such methods are time consuming, expensive, and inefficient. Furthermore, measurements may become inaccurate over time, thereby increasing the risk of an accident. For example, the walls or ceiling of a tunnel may slowly collapse over time, thereby rendering inaccurate any previous measurements that may be relied upon for clearance of an oversized load for transport along a railroad track.

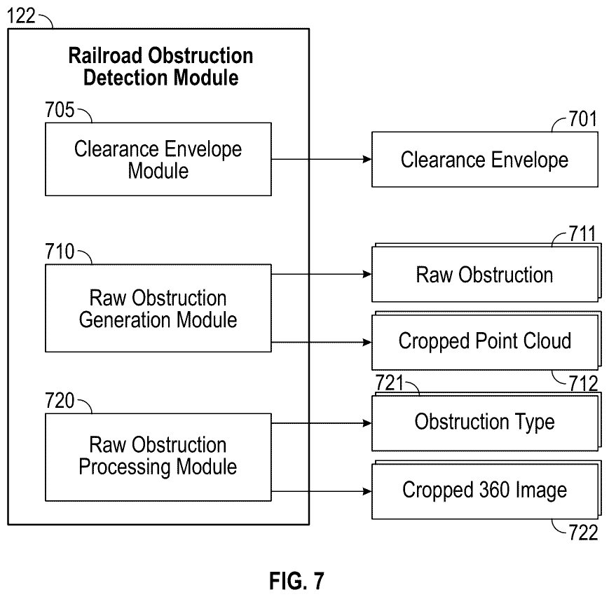

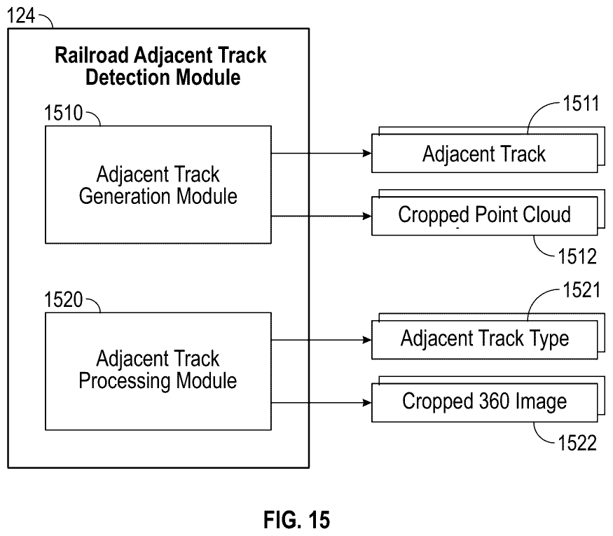

To address these and other problems with transporting oversized loads on a railroad track, embodiments of the disclosure provide systems and methods that automatically determine whether oversized railroad loads have enough clearance to safely travel along a railroad track without contacting physical objects such as signs, tunnel walls, bridge supports, and railcars on adjacent tracks that are located in close proximity to the oversized load. In general, the disclosed embodiments automatically determine clearance for oversized railroad loads using LiDAR point cloud data that is periodically captured by one or more LiDAR sensors attached to a railcar that traverses the railroad track. Clearance for oversized railroad loads may be determined based on one or both of two different factors: 1) obstructions located along a railroad track within a determined clearance envelope, and 2) railroad tracks that are adjacent to the subject railroad track. Embodiments that identify and classify obstructions located along a railroad track are discussed in reference to FIGS. 7-14. Embodiments that identify and classify adjacent railroad tracks are discussed in reference to FIGS. 15-18.

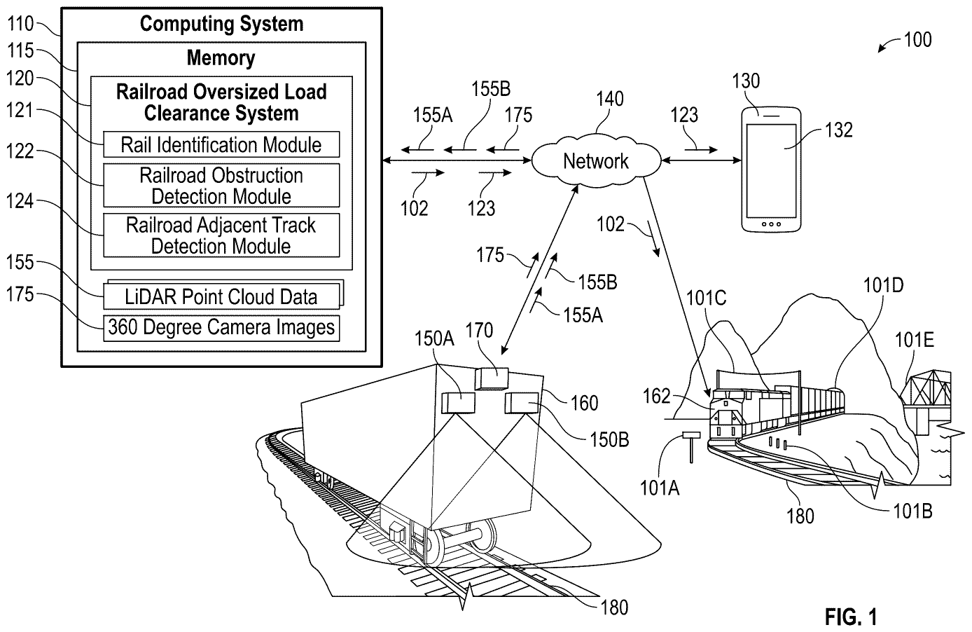

FIG. 1 is a block diagram of an exemplary railroad oversized load clearance system 100, according to certain embodiments of the present disclosure. As shown in FIG. 1, certain embodiments of railroad oversized load clearance system 100 may include a computing system 110, a railroad oversized load clearance module 120, a rail identification module 121, a railroad obstruction detection module 122, a railroad adjacent track detection module 124, a client system 130, a network 140, one or more LiDAR instruments 150 (e.g., 150A-150B), and a 360-degree camera 170. Computing system 110, railroad oversized load clearance module 120, rail identification module 121, railroad obstruction detection module 122, railroad adjacent track detection module 124, client system 130, LiDAR instruments 150, and 360-degree camera 170 are all communicatively coupled with each other using any appropriate wired or wireless communication system or network (e.g., network 140). Computing system 110 includes a computer processor (e.g., processor 1902) and memory 115 (e.g., memory 1904) that stores railroad oversized load clearance module 120, rail identification module 121, railroad obstruction detection module 122, railroad adjacent track detection module 124, LiDAR point cloud data 155, and 360-degree camera images 175. Client system 130 includes an electronic display for displaying a user interface 132. These components, and their individual components, may cooperatively operate to provide functionality in accordance with the discussion herein.

It is noted that the functional blocks, and components thereof, of railroad oversized load clearance system 100 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of railroad oversized load clearance system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of railroad oversized load clearance system 100 are provided for purposes of illustration, rather than by way of limitation and that functionalities described as being provided by different functional blocks may be combined into a single component or may be provided via computing resources disposed in a cloud-based environment accessible over a network, such as network 140.

In general, railroad oversized load clearance system 100 analyzes LiDAR point cloud data 155 generated by one or more LiDAR instruments 150 in order to automatically determine whether oversized railroad loads on train 162 have enough clearance to safely travel along railroad track 180 without contacting obstructions 101 (e.g., 101A-101E) or railcars on adjacent tracks 180 that are located in close proximity to the primary railroad track 180. LiDAR point cloud data 155 provides locations of points of objects (e.g., obstructions 101) and surfaces within the railroad track environment around railroad track 180. In order to automatically determine whether oversized railroad loads on train 162 have enough clearance to safely travel along railroad track 180 without contacting obstructions 101 or railcars on adjacent tracks 180, some embodiments of railroad oversized load clearance system 100 utilize one or both of railroad obstruction detection module 122 and railroad adjacent track detection module 124. Railroad obstruction detection module 122 may be used to analyze LiDAR point cloud data 155 to determine whether any obstructions 101 along railroad track 180 are located within a determined clearance envelope 701. The clearance envelope 701 may correspond to the dimensions of the oversized load on train 162, user input, or any predetermined envelope size. Railroad adjacent track detection module 124 may additionally or alternately be used to determine whether there are any adjacent railroad tracks to railroad track 180. Any obstructions 101 within clearance envelope 701 detected by railroad obstruction detection module 122 may be classified by railroad obstruction detection module 122, stored in a database, and displayed to a user for confirmation/review of the obstruction 101. Similarly, any adjacent tracks (e.g., adjacent track 1511) detected by railroad adjacent track detection module 124 may be classified by railroad adjacent track detection module 124, stored in a database, and displayed to a user for confirmation/review of the adjacent track. In some embodiments, if no obstructions 101 or adjacent tracks 1511 are detected by railroad oversized load clearance module 120, an oversized load clearance signal 102 may be electronically transmitted (e.g., via network 140) to train 162 or another computing system 110. Oversized load clearance signal 102 indicates that an oversized load on train 162 may safely travel along railroad track 180 without contacting obstructions 101 or railcars on adjacent tracks 180 that are located in close proximity to the primary railroad track 180.

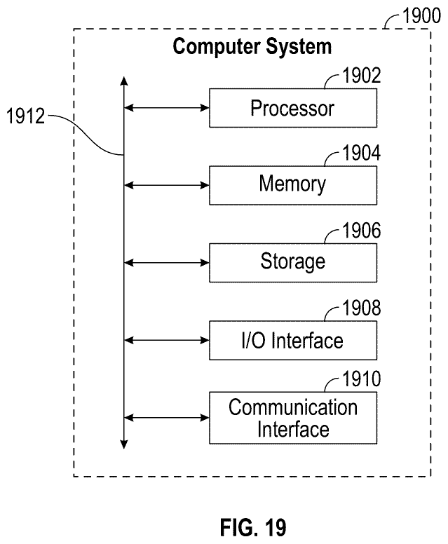

Computing system 110 may be any appropriate computing system in any suitable physical form. As example and not by way of limitation, computing system 110 may be an embedded computer system, a system-on-chip (SOC), a single-board computer system (SBC) (such as, for example, a computer-on-module (COM) or system-on-module (SOM)), a desktop computer system, a laptop or notebook computer system, a mainframe, a mesh of computer systems, a mobile telephone, a personal digital assistant (PDA), a server, a tablet computer system, an augmented/virtual reality device, or a combination of two or more of these. Where appropriate, computing system 110 may include one or more computer systems; be unitary or distributed; span multiple locations; span multiple machines; span multiple data centers; or reside in a cloud, which may include one or more cloud components in one or more networks. Where appropriate, computing system 110 may perform without substantial spatial or temporal limitation one or more steps of one or more methods described or illustrated herein. As an example, and not by way of limitation, computing system 110 may perform in real time or in batch mode one or more steps of one or more methods described or illustrated herein. Computing system 110 may perform at different times or at different locations one or more steps of one or more methods described or illustrated herein, where appropriate. A particular example of a computing system 110 is described in reference to FIG. 19.

Computing system 110 includes one or more memory units/devices 115 (collectively herein, “memory 115”) that may store railroad oversized load clearance module 120. Railroad oversized load clearance module 120 may be a software module/application utilized by computing system 110 to analyze LiDAR point cloud data 155 in order to automatically determine whether oversized railroad loads have enough clearance to safely travel along railroad track 180 without contacting obstructions 101 such as signs 101A, posts 101B, overhead wires 101C, tunnel walls 101D, bridge supports 101E, and railcars on adjacent railroad tracks 180 that are located in close proximity to the oversized load, as described herein. Railroad oversized load clearance module 120 represents any suitable set of instructions, logic, or code embodied in a computer-readable storage medium. For example, railroad oversized load clearance module 120 may be embodied in memory 115, a disk, a CD, or a flash drive. In particular embodiments, railroad oversized load clearance module 120 may include instructions (e.g., a software application) executable by a computer processor to perform some or all of the functions described herein.

In some embodiments, railroad oversized load clearance module 120 may include rail identification module 121, railroad obstruction detection module 122, and railroad adjacent track detection module 124. In general, rail identification module 121 determines characteristics of railroad track 180 (e.g., identified rails 311, top-of-rails 312, track centerline 321, track curvature 331, and track cross-level 341), railroad obstruction detection module 122 determines a clearance envelope (i.e., clearance envelope 701) and whether any obstructions 101 are located within the clearance envelope, and railroad adjacent track detection module 124 identifies any adjacent railroad tracks (i.e., adjacent track 1511) to the subject railroad track 180. The operations of rail identification module 121, railroad obstruction detection module 122, and railroad adjacent track detection module 124 are discussed in more detail below.

In some embodiments, ballast excess and shortage tracking module 120 may send one or more electronic alerts 123 (e.g., a text message and the like) to client system 130 (e.g., a smartphone, a computer, a tablet, etc.) to notify personnel of raw obstruction 711 and/or adjacent track 1511. For example, railroad oversized load clearance module 120 may send an alert 123 to client system 130 that enables a user to review raw obstruction 711 and/or adjacent track 1511. A user may view the alert and take any appropriate action (e.g., approve or edit raw obstruction 711 and/or adjacent track 1511). As a result, the safety and efficiency of operations of railroad track 180 may be improved.

Client system 130 is any appropriate user device for communicating with components of railroad oversized load clearance system 100 over network 140 (e.g., the internet). In particular embodiments, client system 130 may be an electronic device including hardware, software, or embedded logic components or a combination of two or more such components and capable of carrying out the appropriate functionalities implemented or supported by client system 130. As an example, and not by way of limitation, a client system 130 may include a computer system (e.g., computer system 1900) such as a desktop computer, notebook or laptop computer, netbook, a tablet computer, e-book reader, GPS device, camera, personal digital assistant (PDA), handheld electronic device, cellular telephone, smartphone, smartwatch, augmented/virtual reality device such as wearable computer glasses, other suitable electronic device, or any suitable combination thereof. This disclosure contemplates any suitable client system 130. A client system 130 may enable a network user at client system 130 to access network 140. A client system 130 may enable a user to communicate with other users at other client systems 130. Client system 130 may include an electronic display that displays graphical user interface 132, a processor such processor 1902, and memory such as memory 1904.

Network 140 allows communication between and amongst the various components of railroad oversized load clearance system 100. This disclosure contemplates network 140 being any suitable network operable to facilitate communication between the components of railroad oversized load clearance system 100. Network 140 may include any interconnecting system capable of transmitting audio, video, signals, data, messages, or any combination of the preceding. Network 140 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network.

LiDAR instrument 150 is any LiDAR system or device that is capable of scanning railroad track 180 and the environment around railroad track 180 as rail vehicle 160 traverses railroad track 180. In some embodiments, railroad oversized load clearance system 100 includes a single LiDAR instrument 150 that is attached to rail vehicle 160. In other embodiments, railroad oversized load clearance system 100 includes two or more LiDAR instruments 150 attached to rail vehicle 160 (e.g., LiDAR instrument 150A, LiDAR instrument 150B, etc.). In general, LiDAR instrument 150 produces LiDAR point cloud data 155 and electronically transmits LiDAR point cloud data 155 to computing system 110 via network 140 (e.g., either directly or via another computing system 110 onboard rail vehicle 160). For example, in embodiments that include two LiDAR instruments 150, a first LiDAR instrument 150A produces LiDAR point cloud data 155A corresponding to one side of rail vehicle 160 (e.g., the left side of rail vehicle 160), and a second LiDAR instrument 150B produces LiDAR point cloud data 155B corresponding to the other side of rail vehicle 160 (e.g., the right side of rail vehicle 160). In some embodiments, LiDAR point cloud data 155A may overlap with LiDAR point cloud data 155B (i.e., both LiDAR point cloud data 155A and LiDAR point cloud data 155B may cover an overlapping center portion of railroad track 180 as illustrated).

In embodiments that include more than one LiDAR instrument 150, some embodiments of railroad oversized load clearance system 100 may combine and filter multiple LiDAR point cloud data 155 in order to remove noise or false points. For example, railroad oversized load clearance system 100 may combine LiDAR point cloud data 155 from multiple LiDAR instruments 150 (e.g., LiDAR instrument 150A and LiDAR instrument 150B) and then remove any points that are unique to only one data set. As a specific example, if a particular data point is included in LiDAR point cloud data 155A but is not included in LiDAR point cloud data 155B, that particular data point may be considered noise or a false data point and may be removed by railroad oversized load clearance system 100. As used herein, any reference to analyzing LiDAR point cloud data 155 may refer to analyzing data from a single LiDAR instrument 150 or to analyzing combined/filtered data from multiple LiDAR instruments 150.

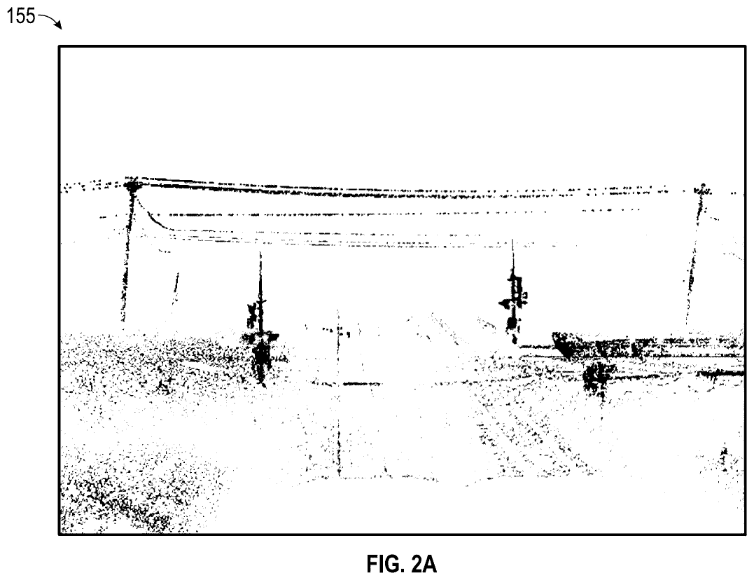

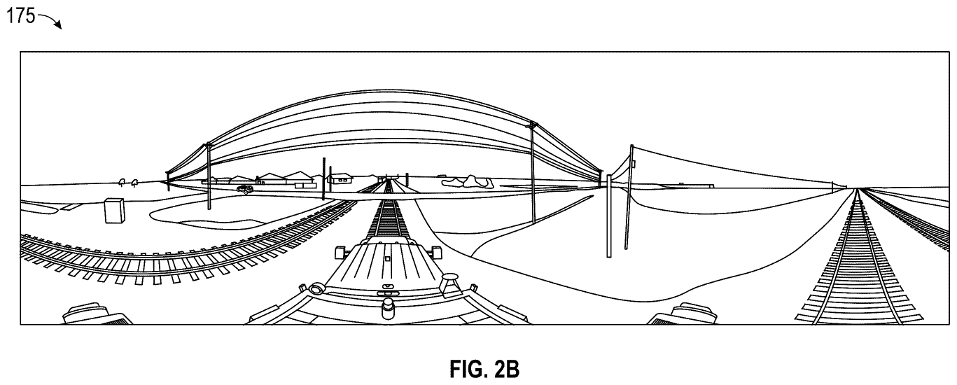

LiDAR point cloud data 155 is data captured by LiDAR instrument 150 while rail vehicle 160 traverses railroad track 180. A particular example of LiDAR point cloud data 155 is illustrated in FIG. 2A. In some embodiments, LiDAR point cloud data 155 captured by LiDAR instrument 150 indicates the locations of objects and surfaces within a railroad track environment (e.g., railroad track 180, the physical area surrounding railroad track 180, obstructions 101, adjacent railroad tracks 180, and the like). Each data point within LiDAR point cloud data 155 may have an associated set of coordinates that spatially locate the point in a three-dimensional environment. The data points within LiDAR point cloud data 155 are analyzed by railroad obstruction detection module 122 and railroad adjacent track detection module 124 in order to determine obstructions 101 and adjacent railroad tracks 180, as described in more detail below.

Rail vehicle 160 is any appropriate vehicle or object that is able to traverse railroad track 180. In some embodiments, for example, rail vehicle 160 may be a railcar or a locomotive of a train. In other embodiments, rail vehicle 160 may be any other appropriate vehicle (e.g., an automobile) that is configured to traverse railroad track 180. 360-degree camera 170 is any appropriate camera device or system that is capable of capturing 360-degree camera images 175. A particular example of a 360-degree camera image 175 is illustrated in FIG. 2B. In some embodiments, railroad oversized load clearance system 100 includes a single 360-degree camera 170 that is attached to rail vehicle 160. In other embodiments, railroad oversized load clearance system 100 includes two or more 360-degree cameras 170 attached to rail vehicle 160. In general, 360-degree camera 170 captures 360-degree camera images 175 and electronically transmits 360-degree camera images 175 to computing system 110 via network 140 (e.g., either directly or via another computing system 110 onboard rail vehicle 160).

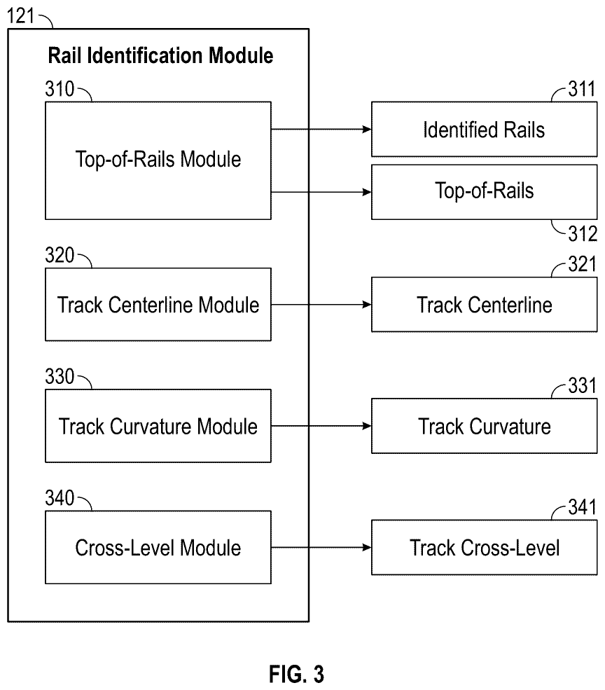

In operation, railroad oversized load clearance system 100 analyzes LiDAR point cloud data 155 generated by one or more LiDAR instruments 150 in order to automatically determine whether oversized loads on train 162 have enough clearance to safely travel along railroad track 180 without contacting obstructions 101 (e.g., 101A-101E) or railcars on adjacent tracks 180 that are located in close proximity to the primary railroad track 180. In order to automatically determine whether oversized railroad loads on train 162 have enough clearance to safely travel along railroad track 180 without contacting obstructions 101 or railcars on adjacent tracks 180, some embodiments of railroad oversized load clearance system 100 may first utilize rail identification module 121 to determine characteristics of railroad track 180. A specific embodiment of rail identification module 121 is discussed in more detail below in reference to FIGS. 3-6. In general, rail identification module 121 analyzes LiDAR point cloud data 155 to determine characteristics of railroad track 180 such as identified rails 311, top-of-rails 312, track centerline 321, track curvature 331, and track cross-level 341. One or more of these track characteristics, once determined by rail identification module 121, are utilized by railroad obstruction detection module 122 and railroad adjacent track detection module 124, as described in reference to FIGS. 7-18 below.

After utilizing rail identification module 121 to determine track characteristics of railroad track 180, some embodiments of railroad oversized load clearance system 100 next utilize railroad obstruction detection module 122 to analyze LiDAR point cloud data 155 to determine whether any obstructions 101 along railroad track 180 are located within a determined clearance envelope 701. The clearance envelope 701 may correspond to the dimensions of the oversized load on train 162, user input, or any predetermined envelope size. Any obstructions 101 within clearance envelope 701 detected by railroad obstruction detection module 122 may be classified by railroad obstruction detection module 122, stored in a database, and displayed to a user for confirmation/review of the obstruction 101. Specific embodiments of railroad obstruction detection module 122 are discussed in more detail below in reference to FIGS. 7-14.

After utilizing rail identification module 121 to determine track characteristics of railroad track 180, some embodiments of railroad oversized load clearance system 100 additionally or alternatively utilize railroad adjacent track detection module 124 to analyze LiDAR point cloud data 155 in order to determine whether there are any railroad tracks that are adjacent to railroad track 180. Any adjacent tracks (e.g., adjacent track 1511) detected by railroad adjacent track detection module 124 may be classified by railroad adjacent track detection module 124, stored in a database, and displayed to a user for confirmation/review of the adjacent track. A specific embodiment of railroad adjacent track detection module 124 is discussed in more detail below in reference to FIGS. 15-18.

In some embodiments, railroad oversized load clearance system 100 may automatically take one or more actions based on the outputs of railroad obstruction detection module 122 and railroad adjacent track detection module 124. For example, if no obstructions 101 are detected by railroad obstruction detection module 122, railroad oversized load clearance module 120 may generate and electronically transmit oversized load clearance signal 102 to train 162 or another computing system 110. Oversized load clearance signal 102 indicates that an oversized load on train 162 may safely travel along railroad track 180 without contacting any obstructions 101. As another example, if no adjacent tracks 1511 are detected by railroad adjacent track detection module 124, railroad oversized load clearance module 120 may generate and electronically transmit oversized load clearance signal 102 to train 162 or another computing system 110 in order to indicate that an oversized load on train 162 may safely travel along railroad track 180 without contacting railcars on adjacent tracks 180 that are located in close proximity to the primary railroad track 180.

FIG. 3 illustrates a rail identification module 121 that may be utilized by railroad oversized load clearance module 120 of railroad oversized load clearance system 100, according to particular embodiments. Rail identification module 121 may be a software module/application (either standalone or included within railroad oversized load clearance module 120) that is utilized by railroad oversized load clearance system 100 to analyze LiDAR point cloud data 155 in order to generate track characteristics (e.g., identified rails 311, top-of-rails 312, track centerline 321, track curvature 331, and track cross-level 341) of railroad track 180, as described in more detail below. Rail identification module 121 (and each of the modules within rail identification module 121) represents any suitable set of instructions, logic, or code embodied in a computer-readable storage medium. For example, rail identification module 121 may be embodied in memory 115, a disk, a CD, or a flash drive. In particular embodiments, rail identification module 121 may include instructions (e.g., a software application) executable by a computer processor to perform some or all of the functions described herein. In some embodiments, rail identification module 121 includes a top-of-rails module 310, a track centerline module 320, a track curvature module 330, and a cross-level module 340, as described in more detail below.

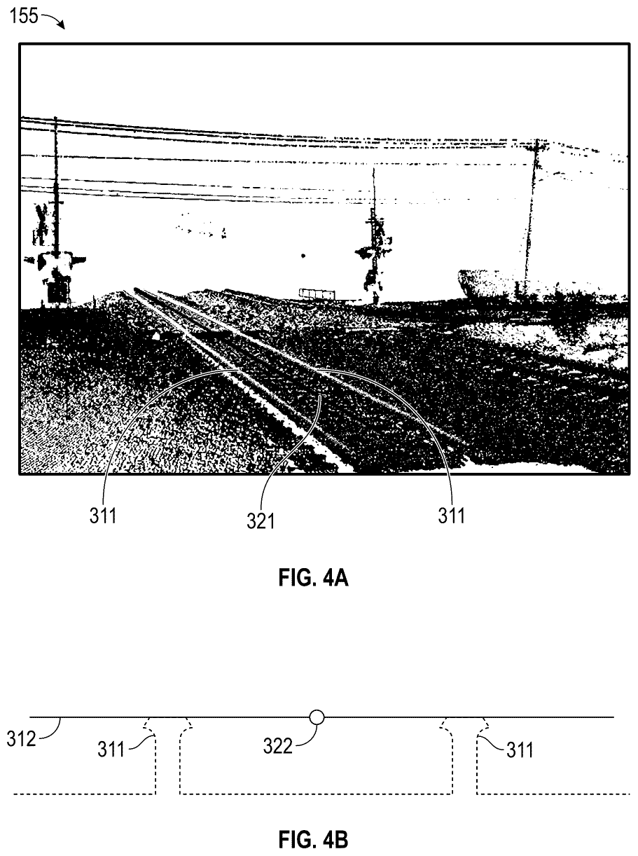

Top-of-rails module 310 is a software module/application (either standalone or included within rail identification module 121) that analyzes LiDAR point cloud data 155 and generates identified rails 311 of railroad track 180 and top-of-rails 312 of the identified rails 311. Examples of identified rails 311 and top-of-rails 312 are illustrated in FIGS. 4A and 4B. In general, identified rails 311 are the main rails of railroad track 180 in a scene within LiDAR point cloud data 155, and top-of-rails 312 is the top portion or surface of the identified rails 311. In some embodiments, top-of-rails module 310 utilizes an advanced deep neural network to analyze LiDAR point cloud data 155 in order to determine identified rails 311 and top-of-rails 312 of railroad track 180 within LiDAR point cloud data 155. As a specific example, some embodiments of track centerline module 1210 utilize the deep-learning model POINTNET to analyze LiDAR point cloud data 155 in order to determine identified rails 311 and top-of-rails 312 of railroad track 180 within LiDAR point cloud data 155.

Track centerline module 320 is a software module/application (either standalone or included within rail identification module 121) that determines a track centerline 321 of railroad track 180. An example of track centerline 321 is illustrated in FIG. 4A. In general, track centerline module 320 utilizes identified rails 311 and/or top-of-rails 312 generated by top-of-rails module 310 to first identify a track centerline point 322 at a predetermined interval along railroad track 180. As a specific example, some embodiments of track centerline module 320 locate track centerline point 322 (illustrated in FIG. 4B) along top-of-rails 312 in the middle of the identified rails 311 (i.e., at the midpoint between the identified rails 311). This process may be repeated by track centerline module 320 for any appropriate interval (e.g., a predetermined interval or user-selected interval) along railroad track 180 in order to generate track centerline 321. For example, track centerline points 322 may be created by track centerline module 320 every foot along railroad track 180 in order to generate track centerline 321.

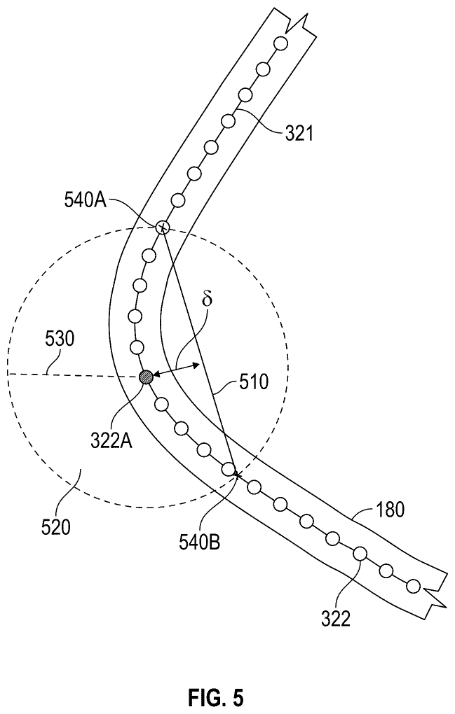

Track curvature module 330 is a software module/application (either standalone or included within rail identification module 121) that determines a track curvature 331 of railroad track 180. An example of how some embodiments of track curvature module 330 determine track curvature 331 is illustrated in FIG. 5. In some embodiments, track curvature 331 (κ) is calculated by track curvature module 330 at each track centerline point 322 (as determined by track centerline module 320) using a virtual chord 510. In some embodiments, virtual chord 510 has a standard fixed length and is moved along track centerline 321 of railroad track 180. At each position, the distance δ between the middle of virtual chord 510 and the centerline of the track is measured. This distance (δ) is linearly converted to the curvature 331 of the track at that point using the equation: κ=αδ, where α is a constant whose sign value is based on the direction of the curvature with respect to the ascending milepost direction (e.g., −5.5 or +5.5). In other embodiments, a circular buffer 520 of a predetermined radius 530 is used to calculate track curvature 331. In these embodiments, circular buffer 520 with predetermined radius 530 (e.g., 25 m) is created at each track centerline point 322 of interest. For example, as illustrated in FIG. 5, circular buffer 520 is created at centerline point 322A. Next, track curvature module 330 finds the intersections 540A and 540B of circular buffer 520 with track centerline 321. Next, track curvature module 330 connects intersections 540A and 540B to create virtual chord 510. Track curvature module 330 then calculates distance δ (e.g., in meters) between centerline point 322A and virtual chord 510. Track curvature 331 at centerline point 322A may then be calculated by track curvature module 330 using the equation: κ=αδ, where α is a constant whose sign value is based on the direction of the curvature with respect to the ascending milepost direction (e.g., −5.5 or +5.5).

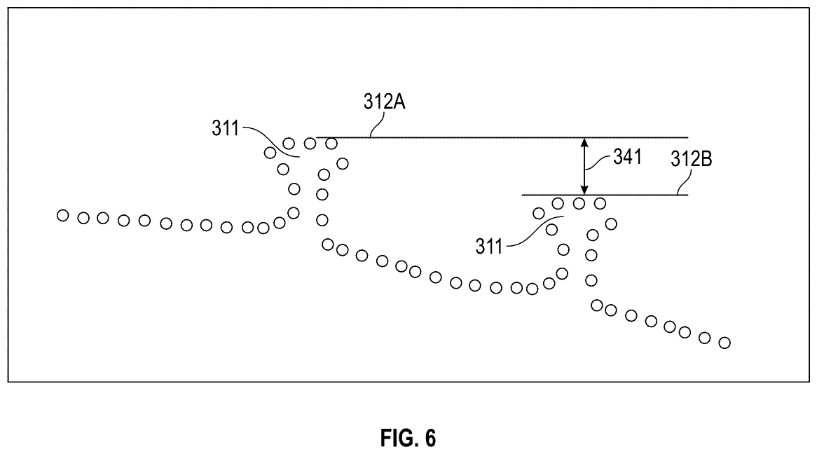

Cross-level module 340 is a software module/application (either standalone or included within rail identification module 121) that determines a track cross-level 341 of railroad track 180. An example of how some embodiments of cross-level module 340 determine track cross-level 341 is illustrated in FIG. 6. In some embodiments, cross-level module 340 first creates a cross section of LiDAR point cloud data 155 at each track centerline point 322 and then reprojects all of the surrounding point cloud data over a 2D plane as illustrated in FIG. 6. Next, cross-level module 340 finds top-of-rails 312A and 312B as described above with respect to top-of-rails module 310. Cross-level module 340 then calculates track cross-level 341 as the distance between top-of-rails 312A and top-of-rails 312B.

FIG. 7 illustrates a railroad obstruction detection module 122 that may be utilized by railroad oversized load clearance module 120 of railroad oversized load clearance system 100, according to particular embodiments. Railroad obstruction detection module 122 may be a software module/application (either standalone or included within railroad oversized load clearance module 120) that is utilized by railroad oversized load clearance system 100 to analyze LiDAR point cloud data 155 in order to identify and classify obstructions 101 around railroad track 180, as described in more detail below. Railroad obstruction detection module 122 (and each of the modules within railroad obstruction detection module 122) represents any suitable set of instructions, logic, or code embodied in a computer-readable storage medium. For example, railroad obstruction detection module 122 may be embodied in memory 115, a disk, a CD, or a flash drive. In particular embodiments, railroad obstruction detection module 122 may include instructions (e.g., a software application) executable by a computer processor to perform some or all of the functions described herein. In some embodiments, railroad obstruction detection module 122 includes a clearance envelope module 705, a raw obstruction generation module 710, and a raw obstruction processing module 720, as described in more detail below.

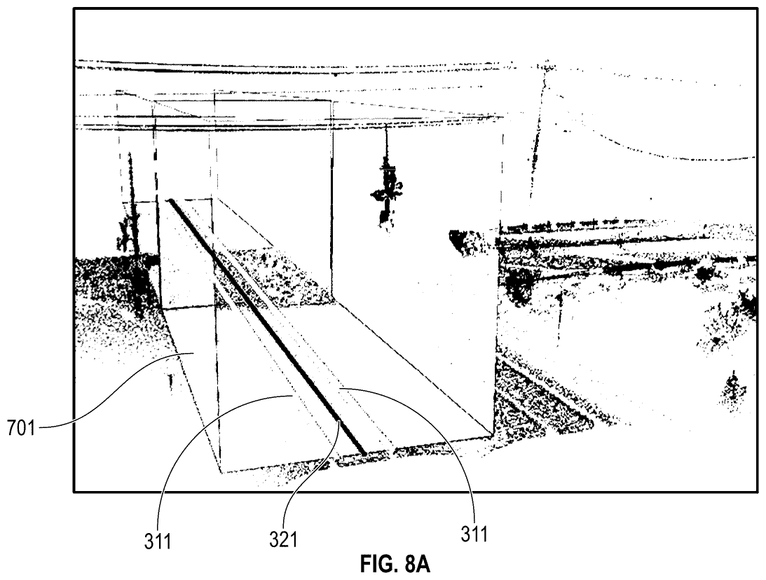

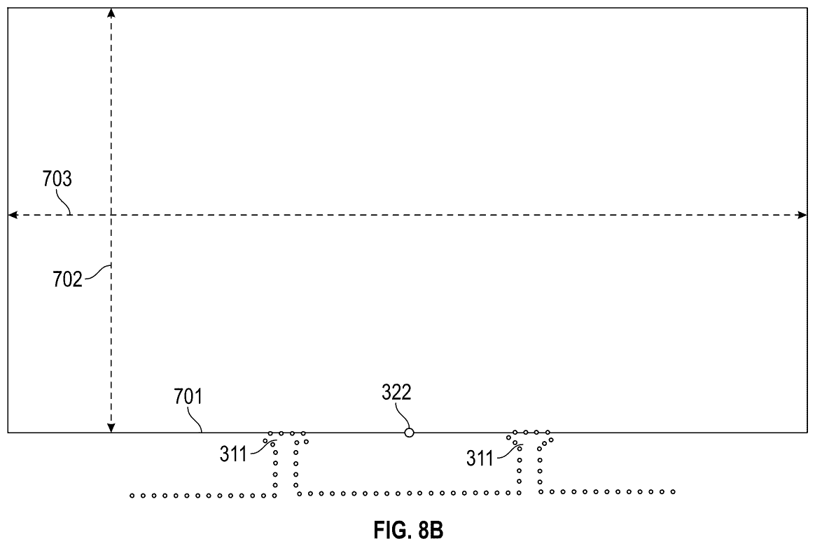

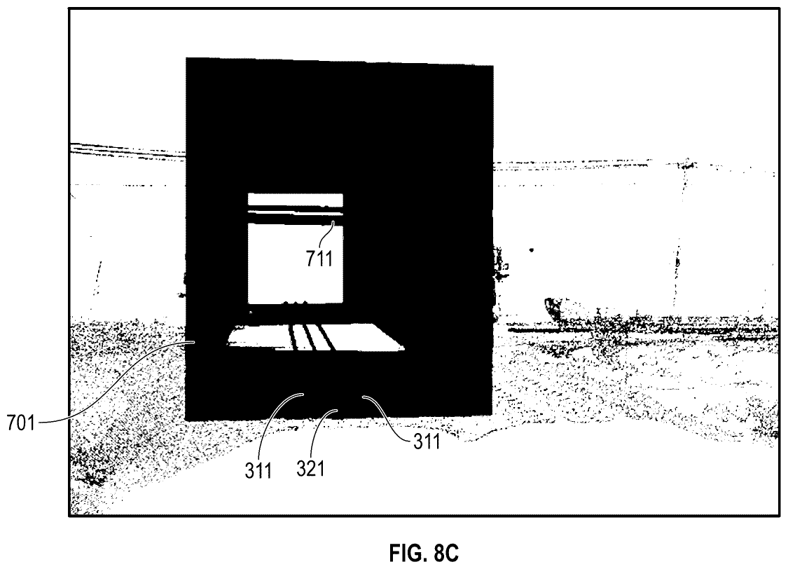

Clearance envelope module 705 is a software module/application (either standalone or included within railroad obstruction detection module 122) that generates clearance envelopes 701 to be used by raw obstruction generation module 710. Examples of clearance envelopes 701 are illustrated in FIGS. 8A and 8B. In general, each clearance envelope 701 is an area around railroad track 180 (e.g., a bounding box) that is used to determine whether objects around railroad track 180 should be considered obstructions 101 that may contact oversized loads being carried by train 162. In some embodiments, clearance envelope 701 is a square or rectangular bounding box as illustrated. In some embodiments, the dimensions of clearance envelope 701 (e.g., height 702 and width 703) are user-defined (e.g., via user interface 132). For example, a user may be presented with options within user interface 132 to select or indicate a shape and the dimensions of clearance envelope 701. For example, a user may select the shape of clearance envelope 701 to be circular, oval, square, rectangular or any other appropriate predefined or user-drawn shape.

In some embodiments, clearance envelope module 705 determines the shape and dimensions of clearance envelope 701 based on predetermined dimensions stored in memory 115. For example, the stored predetermined dimensions for clearance envelope 701 may be based on known sizes of previous oversized loads for a specific train 162 or route. As another example, the stored predetermined dimensions for clearance envelope 701 may be based on a classification or type of oversized loads. For example, oversized loads for “windmill blades” may have first stored predetermined dimensions, and oversized loads for “storage tanks” may have second stored predetermined dimensions. Clearance envelope module 705 may determine the classification or type of oversized load (and thus the dimensions of clearance envelope 701) based on user input, or in some embodiments, clearance envelope module 705 may access a train inventory database in order to determine the classification or type of oversized load for a specific train 162 or route.

In some embodiments, clearance envelope module 705 generates a clearance envelope 701 for each track centerline point 322. For example, as illustrated in FIG. 8B, clearance envelope module 705 may generate a clearance envelope 701 that is centered about track centerline point 322 (i.e., at the midpoint of the width 703 of clearance envelope 701 is aligned with track centerline point 322) and is level with top-of-rails 312 (i.e., the bottom edge of clearance envelope 701 is even with the tops of identified rails 311). Once clearance envelopes 701 are generated for each track centerline point 322 for railroad track 180 (or a section of railroad track 180), clearance envelope module 705 may connect all generated clearance envelopes 701 together in order to create a tunnel of clearance envelopes 701 as illustrated in FIG. 8A.

Raw obstruction generation module 710 is a software module/application (either standalone or included within railroad obstruction detection module 122) that analyzes LiDAR point cloud data 155 in order to identify raw obstructions 711 around railroad track 180 and to generate a cropped point cloud 712 for each identified raw obstruction 711. An example of a raw obstruction 711 being identified by raw obstruction generation module 710 is illustrated in FIG. 8C. In general, each raw obstruction 711 is an obstruction 101 that is determined by raw obstruction generation module 710 to be at least partially located within clearance envelope 701. In the illustrated example of FIG. 8C, for example, obstruction 101C (overhead wires) has been identified by raw obstruction generation module 710 as being at least partially located within clearance envelope 701 and therefore has been identified as a raw obstruction 711.

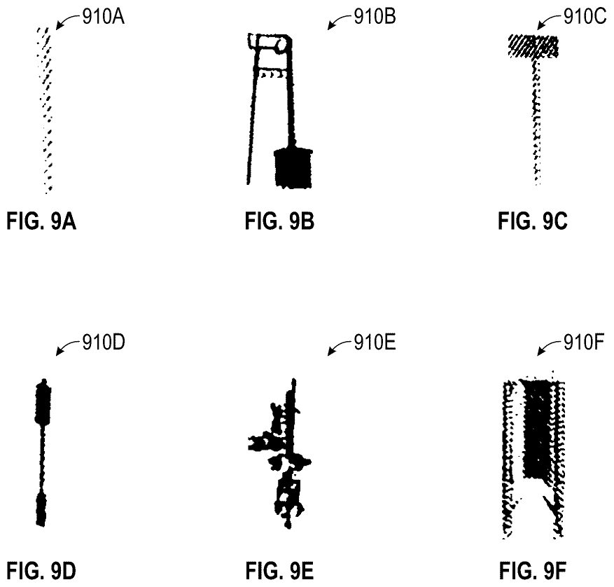

To determine raw obstructions 711, some embodiments of raw obstruction generation module 710 compare coordinates of each point within LiDAR point cloud data 155 to coordinates of clearance envelope 701. If the coordinates of a particular point within LiDAR point cloud data 155 are within the coordinates of clearance envelope 701, the particular point is marked as an obstruction point. Once obstruction points have been determined for a particular scene, some embodiments of raw obstruction generation module 710 may next semantically cluster all of the obstruction points into obstruction clusters 910. Examples of obstructions clusters 910A-910F are illustrated in FIGS. 9A-9F. Each cluster 910 of obstruction points that are determined by raw obstruction generation module 710 may then be identified as a raw obstruction 711.

In some embodiments, raw obstruction generation module 710 filters LiDAR point cloud data 155 in order to identify noise and/or potential false obstruction points within clearance envelope 701. For example, some embodiments of raw obstruction generation module 710 may use a density-based analysis of LiDAR point cloud data 155 in order to filter noise. As another example, some embodiments of raw obstruction generation module 710 may combine and filter LiDAR point cloud data 155 from multiple LiDAR instruments 150 in order to remove noise or false obstruction points. For example, raw obstruction generation module 710 may combine LiDAR point cloud data 155 from multiple LiDAR instruments 150 (e.g., LiDAR instrument 150A and LiDAR instrument 150B) and then remove any points that are unique to only one data set.

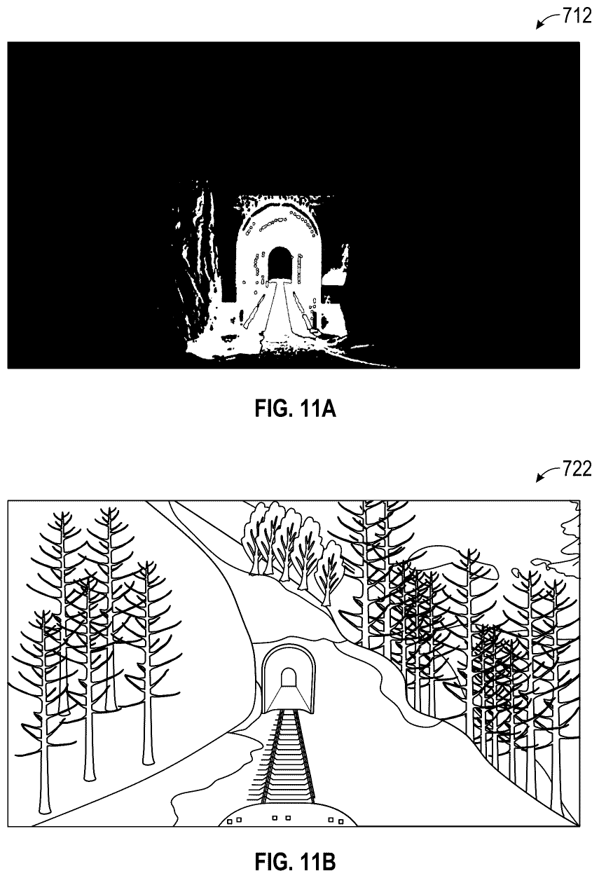

In some embodiments, raw obstruction generation module 710 may generate and store metadata for each identified raw obstruction 711. The metadata may include general information about the raw obstruction 711 such as railway position, GPS location, start/end position, track-chart value, and the like. Furthermore, some embodiments of raw obstruction generation module 710 may additionally generate and store a cropped point cloud 712 for each raw obstruction 711. Cropped point cloud 712 may be a cropped version of LiDAR point cloud data 155 around raw obstruction 711. In some embodiments, raw obstruction 711 and/or obstruction points (e.g., points within LiDAR point cloud data 155 that are within clearance envelope 701) may be highlighted (e.g., a different color, texture, symbol, etc. from its surroundings) within cropped point cloud 712. An example of cropped point cloud 712 is illustrated in FIG. 11A.

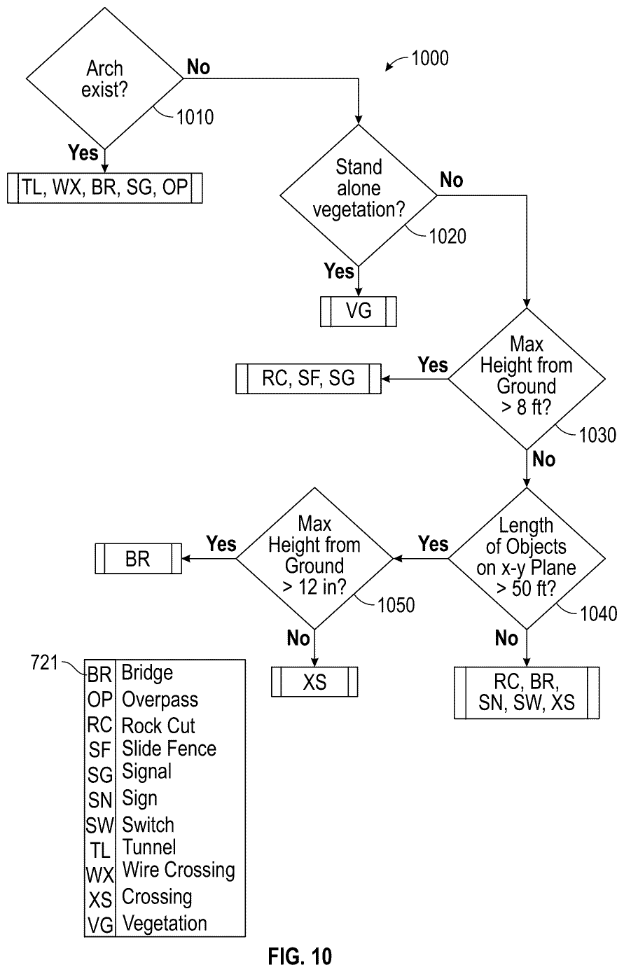

Raw obstruction processing module 720 is a software module/application (either standalone or included within railroad obstruction detection module 122) that analyzes raw obstructions 711 identified by raw obstruction generation module 710 in order to determine an obstruction type 721 and generate a cropped 360-degree image 722 for each identified raw obstruction 711. In general, obstruction type 721 is a label that identifies the type of obstruction for raw obstruction 711. The determined obstruction type 721 for each raw obstruction 711 may be stored and used to later filter or sort raw obstructions 711. An example of a method that may be used by raw obstruction processing module 720 to determine obstruction types 721 is illustrated in FIG. 10, and an example of a cropped 360-degree image 722 that may be generated by raw obstruction processing module 720 is illustrated in FIG. 11B.

FIG. 10 is a chart illustrating a method 1000 that may be used by raw obstruction processing module 720 to determine obstruction types 721, according to particular embodiments. In general, method 1000 includes using a decision tree and one or more deep learning models. At step 1010, raw obstruction processing module 720 determines whether raw obstruction 711 contains an arch. In some embodiments, raw obstruction processing module 720 determines whether or not raw obstruction 711 includes an arch by utilizing an advanced deep neural network. As a specific example, some embodiments of raw obstruction processing module 720 utilize the deep-learning model POINTNET (3D) in step 1010 to determine whether raw obstruction 711 contains an arch. If raw obstruction processing module 720 determines in step 1010 that raw obstruction 711 contains an arch, the following obstruction types 721 may be applied to the raw obstruction 711: tunnel, bridge, wire crossing, signal, and overpass. If raw obstruction processing module 720 determines in step 1010 that raw obstruction 711 does not contain an arch, method 1000 may proceed to step 1020.

At step 1020, raw obstruction processing module 720 determines whether raw obstruction 711 contains stand-alone vegetation. In some embodiments, raw obstruction processing module 720 determines whether or not raw obstruction 711 includes stand-alone vegetation in step 1020 by utilizing an advanced deep neural network. As a specific example, some embodiments of raw obstruction processing module 720 utilize the deep-learning model POINTNET (3D) in step 1020 to determine whether raw obstruction 711 contains stand-alone vegetation. If raw obstruction processing module 720 determines in step 1020 that raw obstruction 711 contains stand-alone vegetation, the obstruction type 721 of “vegetation” may be applied to the raw obstruction 711. If raw obstruction processing module 720 determines in step 1020 that raw obstruction 711 does not contain stand-alone vegetation, method 1000 may proceed to step 1030. In some embodiments, if the obstruction is on both sides of railroad track 180, raw obstruction processing module 720 may process the densest side in step 1020.

At step 1030, raw obstruction processing module 720 determines whether the maximum height from the ground for raw obstruction 711 is greater than a predetermined height (e.g., eight feet). In some embodiments, raw obstruction processing module 720 determines whether the maximum height from the ground for raw obstruction 711 is greater than the predetermined height in step 1030 by utilizing an advanced deep neural network. As a specific example, some embodiments of raw obstruction processing module 720 utilize the deep-learning model POINTNET (2D) in step 1030 to determine whether the maximum height from the ground for raw obstruction 711 is greater than the predetermined height. If raw obstruction processing module 720 determines in step 1030 that the maximum height from the ground for raw obstruction 711 is greater than the predetermined height, the following obstruction types 721 may be applied to the raw obstruction 711: rock cut, slide fence, and signal. If raw obstruction processing module 720 determines in step 1030 that the maximum height from the ground for raw obstruction 711 is not greater than the predetermined height, method 1000 may proceed to step 1040.

At step 1040, raw obstruction processing module 720 determines whether the length of raw obstruction 711 on the x-y plane is greater than a predetermined length (e.g., fifty feet). In some embodiments, raw obstruction processing module 720 determines whether the length of raw obstruction 711 on the x-y plane is greater than the predetermined length in step 1040 by utilizing an advanced deep neural network. As a specific example, some embodiments of raw obstruction processing module 720 utilize the deep-learning model POINTNET (3D) in step 1040 to determine whether the length of raw obstruction 711 on the x-y plane is greater than the predetermined length. If raw obstruction processing module 720 determines in step 1040 that the length of raw obstruction 711 on the x-y plane is not greater than the predetermined length, the following obstruction types 721 may be applied to the raw obstruction 711: rock cut, bridge, sign, switch, and crossing. If raw obstruction processing module 720 determines in step 1040 that the length of raw obstruction 711 on the x-y plane is greater than the predetermined length, method 1000 may proceed to step 1050.

At step 1050, raw obstruction processing module 720 determines whether the maximum height from the ground for raw obstruction 711 is greater than a predetermined height that is less than the height used in step 1030 (e.g., one foot). In some embodiments, raw obstruction processing module 720 determines whether the maximum height from the ground for raw obstruction 711 is greater than the predetermined height in step 1050 by utilizing an advanced deep neural network. As a specific example, some embodiments of raw obstruction processing module 720 utilize the deep-learning model POINTNET (2D) in step 1050 to determine whether the maximum height from the ground for raw obstruction 711 is greater than the predetermined height of step 1050. If raw obstruction processing module 720 determines in step 1050 that the maximum height from the ground for raw obstruction 711 is greater than the predetermined height of step 1050, the obstruction type 721 of “bridge” may be applied to the raw obstruction 711. If raw obstruction processing module 720 determines in step 1050 that the maximum height from the ground for raw obstruction 711 is not greater than the predetermined height of step 1050, the obstruction type 721 of “crossing” may be applied to the raw obstruction 711.

In some embodiments, method 1000 additionally includes determining the 2D measurements of the most critical points of raw obstruction 711 prior to step 1010. Furthermore, method 1000 may also modify the measurement format based on downstream modules prior to step 1010. In this process, the number of measurement points may drop significantly in order to speed up processing and to minimize required computer resources. For example, in order to reduce the number of measurement points, some embodiments may only select the most critical points, may limit the total number of points to a specific amount (e.g., 90 points), and/or may avoid adding artifacts to the inner edge profile of raw obstruction 711.

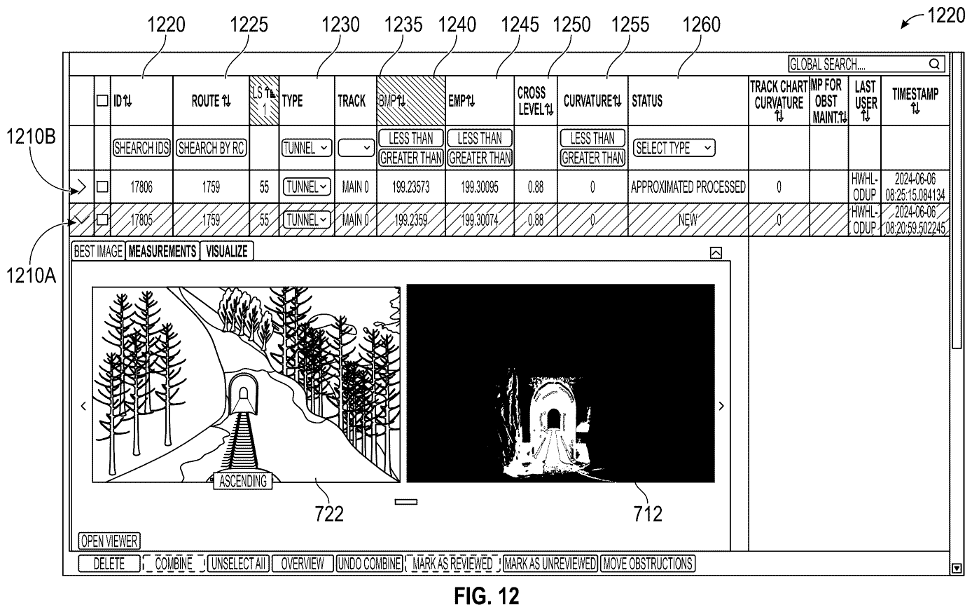

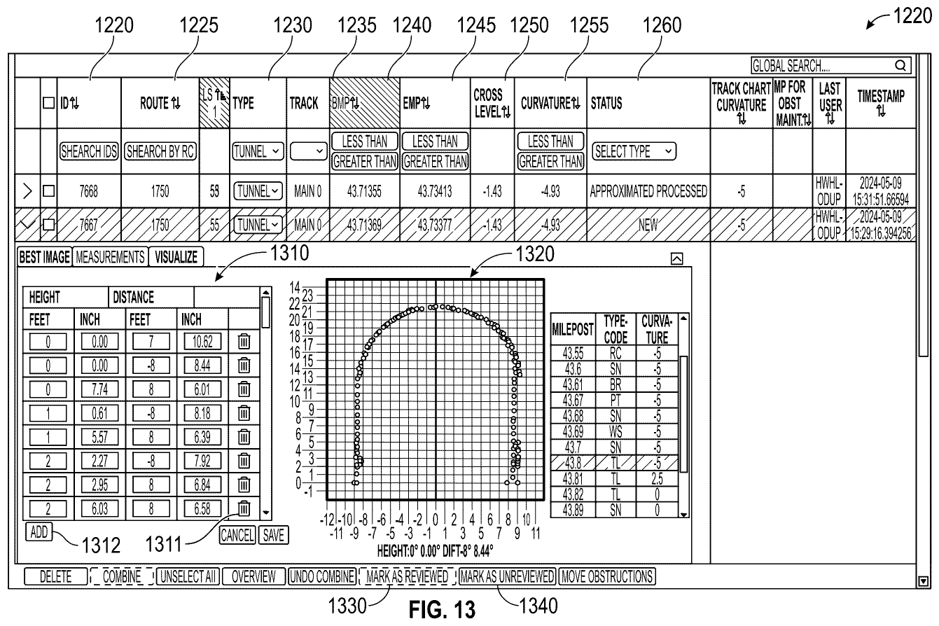

Once raw obstruction processing module 720 determines one or more obstruction types 721 for each raw obstruction 711, raw obstructions 711 and their associated obstruction types 721 may be stored in memory 115 for later viewing and processing. For example, raw obstructions 711 and their associated obstruction types 721 may be displayed for review in graphical user interfaces 1200 and 1300 as illustrated in FIGS. 12 and 13. Furthermore, raw obstruction processing module 720 may access 360-degree camera images 175, determine at least one 360-degree camera image 175 that shows raw obstruction 711 (e.g., based on GPS location or milepost marker), and then create cropped 360-degree image 722 of the raw obstruction 711. An example of a cropped 360-degree image 722 that may be generated by raw obstruction processing module 720 is illustrated in FIG. 11B. In general, cropped 360-degree image 722 is an actual photograph of raw obstruction 711 and generally may be cropped to match cropped point cloud 712.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method including the particular steps of the method of FIG. 10, this disclosure contemplates any suitable method including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

FIGS. 12 and 13 illustrate a graphical user interface 1200 that may permit user review of obstructions 101 identified by railroad oversized load clearance system 100, according to particular embodiments. As illustrated in FIG. 12, some embodiments of graphical user interface 1200 may include multiple obstruction entries 1210 (e.g., 1210A and 1210B). Each obstruction entry 1210 may correspond to a particular raw obstruction 711 identified by raw obstruction generation module 710. Each obstruction entry 1210 may include an obstruction ID 1220, a route ID 1225, an obstruction type 1230, a track ID 1235, a beginning mile post 1240, an ending mile post 1245, a cross level 1250, a curvature 1255, and a status 1260. Obstruction ID 1220 may indicate a unique identifier applied to the particular raw obstruction 711 of the obstruction entry 1210. Route ID 1225 indicates an identification of the route of the railroad track 180 on which the particular raw obstruction 711 of the obstruction entry 1210 is located. Obstruction type 1230 corresponds to obstruction type 721 and indicates the one or more obstruction types 721 that raw obstruction processing module 720 identified for the particular raw obstruction 711 of the obstruction entry 1210. Obstruction type 1230 may be changed by the user based on manual review. Track ID 1235 indicates an identification of the railroad track 180 on which the particular raw obstruction 711 of the obstruction entry 1210 is located. Beginning mile post 1240 indicates a beginning milepost marker associated with the particular raw obstruction 711 of the obstruction entry 1210. Ending mile post 1245 indicates an ending milepost marker associated with the particular raw obstruction 711 of the obstruction entry 1210. Cross level 1250 indicates any track cross-level 341 (e.g., as calculated by cross-level module 340) associated with railroad track 180 at the location of the particular raw obstruction 711 of the obstruction entry 1210. Curvature 1255 indicates any track curvature 331 (e.g., as calculated by track curvature module 330) associated with railroad track 180 at the location of the particular raw obstruction 711 of the obstruction entry 1210. Status 1260 indicates a status associated with the particular raw obstruction 711 of the obstruction entry 1210 (e.g., New, Completed, etc.).

In addition to items 1220-1260, each obstruction entry 1210 includes a cropped 360-degree image 722 and a cropped point cloud 712 associated with the particular raw obstruction 711 of the obstruction entry 1210. In some embodiments, cropped 360-degree image 722 and cropped point cloud 712 may be displayed in response to a user selection of an obstruction entry 1210. In some embodiments, graphical user interface 1200 includes a user-selectable element that permits a user to step through multiple images in sequential order along railroad track 180 in order to view different cropped 360-degree images 722 and cropped point clouds 712.

As illustrated in FIG. 13, some embodiments of graphical user interface 1200 may graphically display various points from LiDAR point cloud data 155 that are associated with the particular raw obstruction 711 of the selected obstruction entry 1210. For example, some embodiments include a chart 1310 that lists height and distance measurements associated with each point from LiDAR point cloud data 155 that is associated with the particular raw obstruction 711 of the selected obstruction entry 1210. For each point, chart 1310 may include a user element 1311 that permits a user to delete the particular point. Chart 1310 may also include a user element 1312 that permits a user to add a point to chart 1310. Some embodiments of graphical user interface 1200 also may include a grid 1320 that graphically charts the points from chart 1310. This may enable the user to more accurately visualize the particular raw obstruction 711 of the selected obstruction entry 1210. Graphical user interface 1200 may also include user elements 1330 and 1340. User element 1330 may enable the user to mark the particular raw obstruction 711 of the selected obstruction entry 1210 as Reviewed. User element 1340 may enable the user to mark the particular raw obstruction 711 of the selected obstruction entry 1210 as Unreviewed.

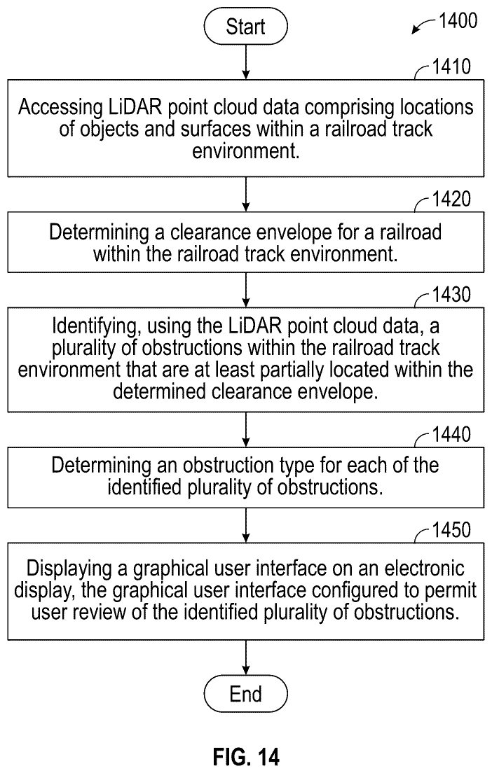

FIG. 14 is a chart illustrating a method 1400 for determining obstructions in a railroad track environment, according to particular embodiments. In some embodiments, method 1400 may be performed by railroad obstruction detection module 122 of railroad oversized load clearance system 100. At step 1410, method 1400 accesses LiDAR point cloud data stored in one or more memory units. In some embodiments, the LiDAR point cloud data includes locations of objects and surfaces within a railroad track environment. In some embodiments, the LiDAR point cloud data is LiDAR point cloud data 155. In some embodiments, the LiDAR point cloud data 155 is generated by one or more LiDAR instruments attached to a rail vehicle.

At step 1420, method 1400 determines a clearance envelope for a railroad track within the railroad track environment. In some embodiments, the clearance envelope is clearance envelope 701. In some embodiments, the clearance envelope is a bounding box that defines a shape and a size of an oversized load in which to test for obstructions such as obstructions 101. In some embodiments, the clearance envelope is a rectangle, a square, a circle, or any other appropriate shape of any appropriate dimensions. In some embodiments, method 1400 determines the shape and dimensions of the clearance envelope based on user inputs. In other embodiments, method 1400 determines the shape and dimensions of the clearance envelope based on predetermined dimensions stored in memory. The predetermined dimensions may be based on known sizes of previous oversized loads for a specific train or route, or the predetermined dimensions may be based on a classification or type of oversized loads.

In some embodiments, step 1420 includes determining, by analyzing the LiDAR point cloud data, rails of a railroad track, a top-of-rails position of the rails, a plurality of track centerline points, and a track centerline of the railroad track. Step 1420 may further include positioning the clearance envelope along the track centerline of the railroad track such that a lower edge of the clearance envelope is even with the top-of-rails at each track centerline point and is centered about each track centerline point.

At step 1430, method 1400 identifies, using the LiDAR point cloud data, a plurality of obstructions within the railroad track environment that are at least partially located within the determined clearance envelope. In some embodiments, step 1430 is performed by raw obstruction generation module 710. In some embodiments, the plurality of obstructions are raw obstructions 711. In some embodiments, method 1400 determines the plurality of obstructions within the railroad track environment that are at least partially located within the determined clearance envelope by comparing coordinates of each point within the LiDAR point cloud data to coordinates of the determined clearance envelope of step 1420. If a particular point within the LiDAR point cloud data is determined to be within the determined clearance envelope, the point is marked as an obstruction point. Once all obstruction points have been identified for a particular clearance envelope, method 1400 may semantically cluster all of the obstruction points into obstruction clusters such as obstruction clusters 910. The obstruction clusters may be identified by method 1400 in step 1430 as the plurality of obstructions.

At step 1440, method 1400 determines an obstruction type for each of the identified plurality of obstructions of step 1430. In some embodiments, step 1440 is performed by raw obstruction processing module 720. In some embodiments, step 1440 includes using a decision tree and one or more deep-learning models. In some embodiments, step 1440 includes using method 1000 as described in reference to FIG. 10.

At step 1450, method 1400 displays a graphical user interface on an electronic display. In some embodiments, the graphical user interface is graphical user interface 1200 that is displayed on client system 130. In some embodiments, the graphical user interface is configured to permit user review of the identified plurality of obstructions of step 1430. In some embodiments, the graphical user interface is configured to display the determined obstruction type (e.g., obstruction type 721) for each particular identified obstruction and one or more images of the particular identified obstruction. In some embodiments, the one or more images of the particular identified obstruction includes a cropped portion of the LiDAR point cloud data (e.g., cropped point cloud 712) that includes the particular identified obstruction. In some embodiments, the one or more images of the particular identified obstruction comprises a cropped image of one of a plurality of 360-degree images captured by a 360-degree camera attached to a rail vehicle. After step 1450, method 1400 may end.

In some embodiments, method 1400 additionally includes determining that a particular train route is devoid of any identified obstructions and electronically transmitting a clearance signal to a train or another system. In some embodiments, the clearance signal indicates that the particular train route is devoid of any identified obstructions. In some embodiments, the clearance signal is oversized load clearance signal 102.

Particular embodiments may repeat one or more steps of the method of FIG. 14, where appropriate. Although this disclosure describes and illustrates particular steps of the method of FIG. 14 as occurring in a particular order, this disclosure contemplates any suitable steps of the method of FIG. 14 occurring in any suitable order. Moreover, although this disclosure describes and illustrates an example method including the particular steps of the method of FIG. 14, this disclosure contemplates any suitable method including any suitable steps, which may include all, some, or none of the steps of the method of FIG. 14, where appropriate. Furthermore, although this disclosure describes and illustrates particular components, devices, or systems carrying out particular steps of the method of FIG. 14, this disclosure contemplates any suitable combination of any suitable components, devices, or systems carrying out any suitable steps of the method of FIG. 14.

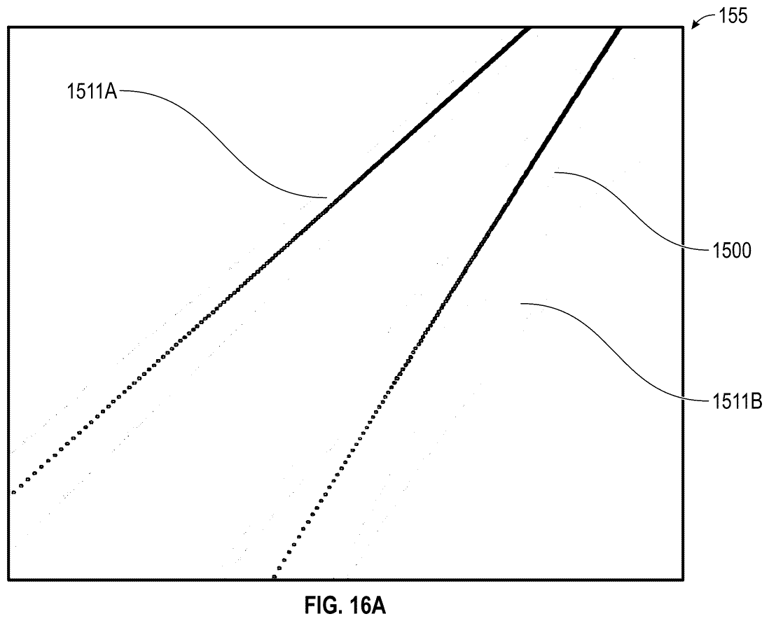

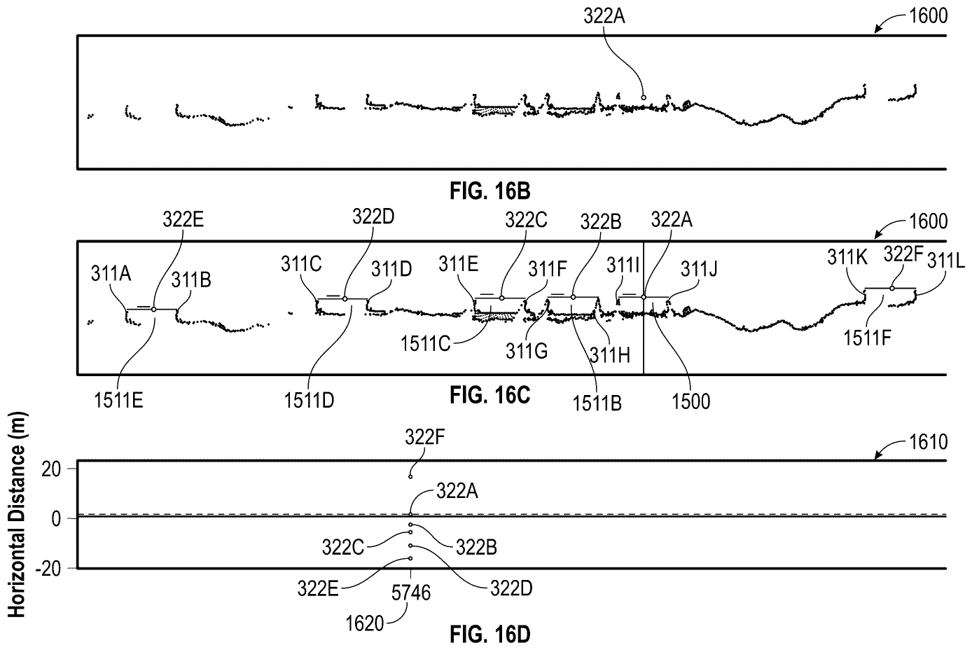

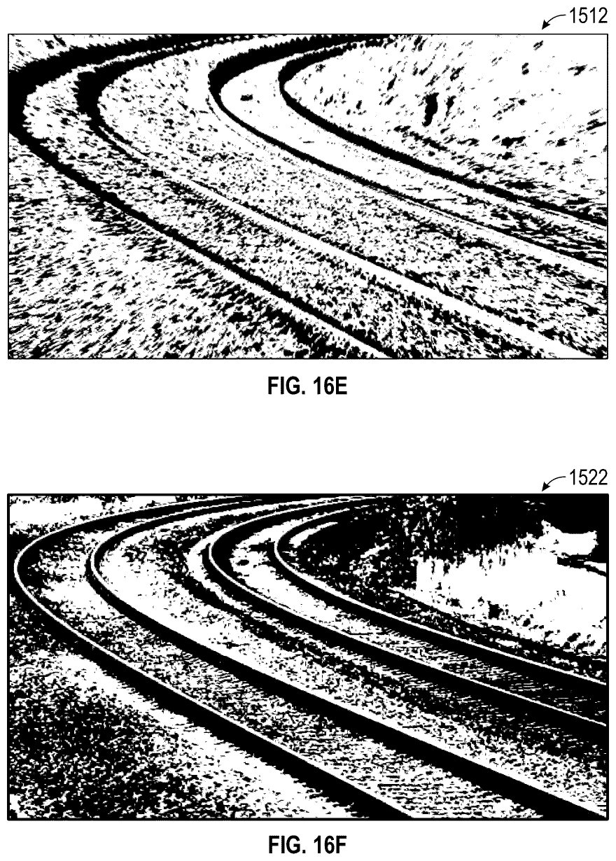

FIG. 15 illustrates a railroad adjacent track detection module 124 that may be utilized by railroad oversized load clearance module 120 of railroad oversized load clearance system 100, according to particular embodiments. In general, railroad adjacent track detection module 124 analyzes LiDAR point cloud data 155 in order to detect one or more adjacent tracks 1511 that are adjacent to a subject railroad track 1500. For example, as illustrated in FIG. 16A, railroad adjacent track detection module 124 analyzes LiDAR point cloud data 155 in order to first detect a subject railroad track 1500. Next, railroad adjacent track detection module 124 further analyzes LiDAR point cloud data 155 in order to detect a first adjacent track 1511A and a second adjacent track 1511B. Some embodiments of railroad adjacent track detection module 124 may additionally determine a classification (e.g., an adjacent track type 1521) for each identified adjacent track 1511. In the particular example of FIG. 16A, railroad adjacent track detection module 124 may determine an adjacent track type 1521 of “close track center” for adjacent track 1511A and an adjacent track type 1521 of “cross-over” for adjacent track 1511B.

By detecting adjacent tracks 1511 using railroad adjacent track detection module 124, railroad oversized load clearance system 100 may be able to determine clearance for oversized railroad loads for particular routes. Typically, adjacent railroad tracks are placed a certain distance apart based on typical railcar dimensions in order to prevent railcars from contacting other railcars on adjacent tracks when they pass. However, when transporting oversized loads that may be significantly wider than typical loads, care must be taken in order to avoid contacting other railcars on adjacent tracks. By utilizing railroad adjacent track detection module 124 to detect any adjacent tracks 1511 along a specific route, railroad oversized load clearance system 100 is able to determine whether or not an oversized load will have enough clearance to avoid contacting railcars on adjacent tracks. As a result, safety and efficiency of railroad operations may be increased.

Railroad adjacent track detection module 124 may be a software module/application (either standalone or included within railroad oversized load clearance module 120) that is utilized by railroad oversized load clearance system 100 to analyze LiDAR point cloud data 155 in order to identify and classify adjacent tracks 1511 around a subject railroad track 1500 in order to determine clearance for oversized railroad loads, as described in more detail below. Railroad adjacent track detection module 124 (and each of the modules within railroad adjacent track detection module 124) represents any suitable set of instructions, logic, or code embodied in a computer-readable storage medium. For example, railroad adjacent track detection module 124 may be embodied in memory 115, a disk, a CD, or a flash drive. In particular embodiments, railroad adjacent track detection module 124 may include instructions (e.g., a software application) executable by a computer processor to perform some or all of the functions described herein. In some embodiments, railroad adjacent track detection module 124 includes an adjacent track generation module 1510 and an adjacent track processing module 1520, as described in more detail below.

Adjacent track generation module 1510 is a software module/application (either standalone or included within railroad adjacent track detection module 124) that analyzes LiDAR point cloud data 155 in order to identify adjacent tracks 1511 around a subject railroad track 1500 and to generate a cropped point cloud 1512 for each identified adjacent track 1511. Examples of a subject railroad track 1500 and adjacent tracks 1511 being identified in LiDAR point cloud data 155 are illustrated in FIG. 16A. In general, each adjacent track 1511 is a railroad track 180 that is determined to be adjacent to subject railroad track 1500 by adjacent track generation module 1510. In the illustrated example of FIG. 16A, for example, adjacent tracks 1511A and 1511B have been identified by adjacent track generation module 1510 as being adjacent to subject railroad track 1500.

To identify subject railroad track 1500 and adjacent tracks 1511, some embodiments of adjacent track generation module 1510 first generate cross-sections 1600 of LiDAR point cloud data 155 at each track centerline point 322 (e.g., as generated by track centerline module 320) of at least a portion of railroad track 180. FIG. 16B illustrates an example of cross section 1600 of LiDAR point cloud data 155 at track centerline point 322A that may be generated and analyzed by adjacent track generation module 1510 in order to identify subject railroad track 1500 and adjacent tracks 1511, according to particular embodiments. Once cross section 1600 is generated for a particular track centerline point 322 (e.g., track centerline point 322A in the example of FIG. 16B), adjacent track generation module 1510 may then proceed to analyze cross section 1600 in order to generate identified rails 311, as described above in reference to top-of-rails module 310. FIG. 16C illustrates cross section 1600 with identified rails 311 (e.g., 311A-311L). As a specific example, some embodiments of LiDAR instrument 150 utilize the deep-learning model POINTNET to analyze cross section 1600 in order to determine identified rails 311 within cross section 1600.

Once identified rails 311 have been determined for cross section 1600, some embodiments of adjacent track generation module 1510 may determine subject railroad track 1500 by determining which identified rails 311 are a predetermined distance to the particular track centerline point 322 from which cross-section 1600 was generated (e.g., track centerline point 322A in the example of FIG. 16B). In some embodiments, the predetermined distance is half of the standard gauge of railroad track 180. Each identified rail 311 that is located the predetermined distance from the particular track centerline point 322 (e.g., half of the standard gauge of railroad track 180) may be marked as a rail belonging to subject railroad track 1500, and the pair of rails that are marked as belonging to subject railroad track 1500 together form subject railroad track 1500.

Additionally, once identified rails 311 have been determined for cross section 1600, some embodiments of adjacent track generation module 1510 next attempt to pair together the identified rails 311 not belonging to subject railroad track 1500 in order to determine adjacent tracks 1511. For example, some embodiments may determine distances between adjacent identified rails 311 and then pair two identified rails 311 together that are located a predetermined distance apart from each other. The predetermined distance may be, for example, the standard gauge of a railroad track (e.g., 4 ft. 8.5 inches). In the illustrated example of FIG. 16C, for example, adjacent track generation module 1510 may determine that identified rails 311A-B are located the predetermined distance apart (plus or minus a tolerance amount such as 5%-10%) and therefore pair identified rails 311A-B as adjacent track 1511E. Similarly, identified rails 311C-D may be paired together as adjacent track 1511D, identified rails 311E-F may be paired together as adjacent track 1511C, identified rails 311G-H may be paired together as adjacent track 1511B, and identified rails 311K-L may be paired together as adjacent track 1511F.

In some embodiments, railroad oversized load clearance system 100 may display adjacent tracks 1511 to a user in user interface 132 on client system 130. For example, FIG. 16D illustrates a user interface 1610 that may be used to display adjacent tracks 1511. In this example, user interface 1610 visually displays distances between track centerline points 322 of adjacent tracks 1511 (e.g., track centerline points 322E, 322D, 322C, 322B, and 322F of adjacent tracks 1511E, 1511D, 1511C, 1511B, and 1511F) and track centerline point 322A of subject railroad track 1500. As illustrated in FIG. 16D, user interface 1610 displays, at one or more indicated locations 1620 (e.g., milepost 5746), a horizontal distance (Y-axis) between track centerline points 322 of adjacent tracks 1511 and track centerline point 322A of subject railroad track 1500, wherein track centerline point 322A of subject railroad track 1500 is centered at zero on the Y-axis. As a result, a user may quickly and easily comprehend distances between subject railroad track 1500 and adjacent tracks 1511.

In some embodiments, adjacent track generation module 1510 may generate and store metadata for each identified adjacent track 1511. The metadata may include general information about the adjacent track 1511 such as railway position, GPS location, start/end position, track-chart value, and the like. Furthermore, some embodiments of adjacent track generation module 1510 may additionally generate and store a cropped point cloud 1512 for each adjacent track 1511. Cropped point cloud 1512 may be a cropped version of LiDAR point cloud data 155 around adjacent track 1511. In some embodiments, identified rails 311 of each adjacent track 1511 may be highlighted (e.g., a different color, texture, symbol, etc. from its surroundings) within cropped point cloud 1512. An example of a cropped point cloud 1512 is illustrated in FIG. 16E.

Adjacent track processing module 1520 is a software module/application (either standalone or included within railroad adjacent track detection module 124) that analyzes adjacent tracks 1511 identified by adjacent track generation module 1510 in order to determine an adjacent track type 1521 and to generate a cropped 360-degree image 1522 for each identified adjacent track 1511. In general, adjacent track type 1521 is a label that identifies the type of adjacent track 1511. Example of adjacent track type 1521 include “close track center” and “cross-over.” The determined adjacent track type 1521 for each adjacent track 1511 may be stored and used to later filter or sort adjacent track 1511.

To determine adjacent track type 1521 for an adjacent track 1511, some embodiments of adjacent track processing module 1520 utilize a geographic information system (GIS) database. In these embodiments, adjacent track processing module 1520 cross-references location information associated with adjacent track 1511 with the GIS database in order to determine what types of tracks are located at the location of the adjacent track 1511. For example, if a particular adjacent track 1511 is located at a specific GPS location, adjacent track processing module 1520 may search the specific GPS location in the GIS database and determine that a cross-over track is located at that specific GPS location. Adjacent track processing module 1520 may then assign an adjacent track type 1521 of “cross-over” to the particular adjacent track 1511. FIG. 16A illustrates an adjacent track 1511B having an adjacent track type 1521 of “cross-over.”

In some embodiments, adjacent track processing module 1520 may analyze track centerlines 321 of subject railroad track 1500 and an adjacent track 1511 in order to determine whether the adjacent track 1511 should have an adjacent track type 1521 of “close track center.” For example, adjacent track processing module 1520 may first determine track centerlines 321 for subject railroad track 1500 and adjacent track 1511 (e.g., as described above with respect to track centerline module 320). Next, adjacent track processing module 1520 may calculate a distance between the track centerlines 321 of subject railroad track 1500 and adjacent track 1511 across multiple consecutive track centerline points 322. The distance between the track centerlines 321 of subject railroad track 1500 and adjacent track 1511 at each track centerline point 322 may be stored along with adjacent track 1511 and later displayed to a user. If the calculated distances between the track centerlines 321 of subject railroad track 1500 and adjacent track 1511 across multiple consecutive track centerline points 322 are consistent (i.e., not increasing or decreasing) and are less than a predetermined threshold, adjacent track processing module 1520 may determine that the adjacent track 1511 should have an adjacent track type 1521 of “close track center.” In general, an adjacent track type 1521 of “close track center” indicates that the distance between adjacent track 1511 and subject railroad track 1500 is less than the predetermined threshold. FIG. 16A illustrates an adjacent track 1511A having an adjacent track type 1521 of “close track center.”

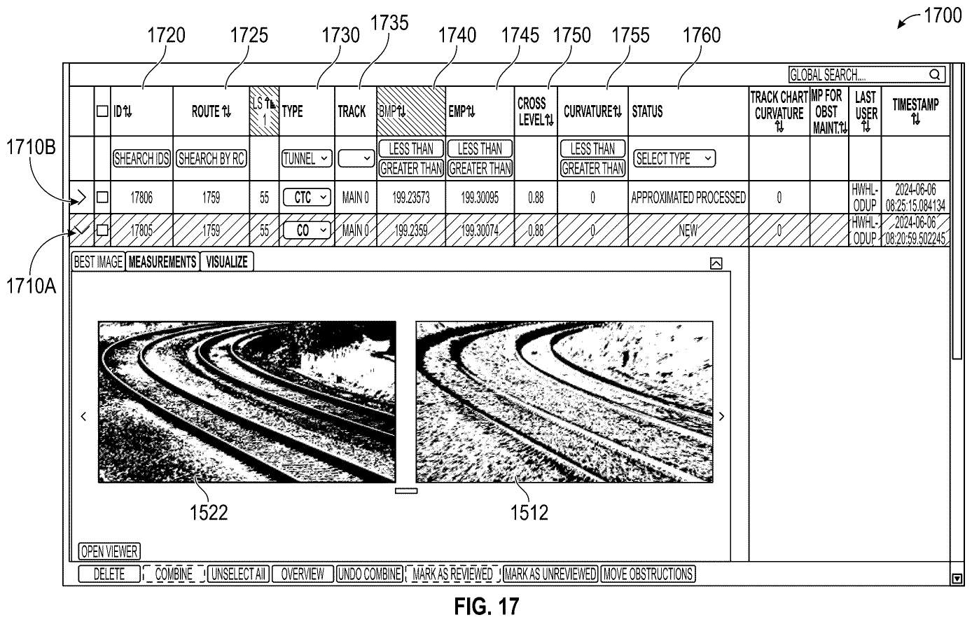

Once adjacent track processing module 1520 determines an adjacent track type 1521 for each adjacent track 1511, adjacent tracks 1511 and their associated adjacent track types 1521 may be stored in memory 115 for later viewing and processing. For example, adjacent tracks 1511 and their associated adjacent track types 1521 may be displayed for review in graphical user interface 1700 as discussed in reference to FIG. 17 below. In some embodiments, adjacent track processing module 1520 may access 360-degree camera images 175, determine at least one 360-degree camera image 175 that shows adjacent track 1511 (e.g., based on GPS location or milepost marker), and then create cropped 360-degree image 1522 of the adjacent track 1511. An example of a cropped 360-degree image 1522 that may be generated by adjacent track processing module 1520 is illustrated in FIG. 16F. In general, cropped 360-degree image 1522 is an actual photograph of adjacent track 1511 and generally may be cropped to match cropped point cloud 1512.

FIG. 17 illustrates a graphical user interface 1700 that may permit user review of adjacent tracks 1511 identified by railroad oversized load clearance system 100, according to particular embodiments. As illustrated in FIG. 17, some embodiments of graphical user interface 1700 may include multiple adjacent track entries 1710 (e.g., 1710A and 1710B). Each adjacent track entry 1710 may correspond to a particular adjacent track 1511 identified by adjacent track generation module 1510. Each adjacent track entry 1710 may include an adjacent track ID 1720, a route ID 1725, an adjacent track type 1730, a track ID 1735, a beginning mile post 1740, an ending mile post 1745, a cross level 1750, a curvature 1755, and a status 1760. Adjacent track ID 1720 may indicate a unique identifier applied to the particular adjacent track 1511 of the adjacent track entry 1710. Route ID 1725 indicates an identification of the route of the railroad track 180 on which the particular adjacent track 1511 of the adjacent track entry 1710 is located. Adjacent track type 1730 corresponds to adjacent track type 1521 and may be prepopulated with the adjacent track type 1521 that adjacent track processing module 1520 identified for the particular adjacent track 1511 of the adjacent track entry 1710 (e.g., “CTC” for close track center, “CO” for cross-over, etc.). Adjacent track type 1730 may be changed by the user based on manual review. Track ID 1735 indicates an identification of the railroad track 180 on which the particular adjacent track 1511 of the adjacent track entry 1710 is located. Beginning mile post 1740 indicates a beginning milepost marker associated with the particular adjacent track 1511 of the adjacent track entry 1710. Ending mile post 1745 indicates an ending milepost marker associated with the particular adjacent track 1511 of the adjacent track entry 1710. Cross level 1750 indicates any track cross-level 341 (e.g., as calculated by cross-level module 340) associated with railroad track 180 at the location of the particular adjacent track 1511 of the adjacent track entry 1710. Curvature 1755 indicates any track curvature 331 (e.g., as calculated by track curvature module 330) associated with railroad track 180 at the location of the particular adjacent track 1511 of the adjacent track entry 1710. Status 1760 indicates a status associated with the particular adjacent track 1511 of the adjacent track entry 1710 (e.g., New, Completed, etc.).

In addition to items 1720-1760, each adjacent track entry 1710 includes a cropped 360-degree image 1522 and a cropped point cloud 1512 associated with the particular adjacent track 1511 of the adjacent track entry 1710. In some embodiments, cropped 360-degree image 1522 and cropped point cloud 1512 may be displayed in response to a user selection of an adjacent track entry 1710. In some embodiments, graphical user interface 1700 includes a user-selectable element that permits a user to step through multiple images in sequential order along railroad track 180 in order to view different cropped 360-degree images 1522 and cropped point clouds 1512.

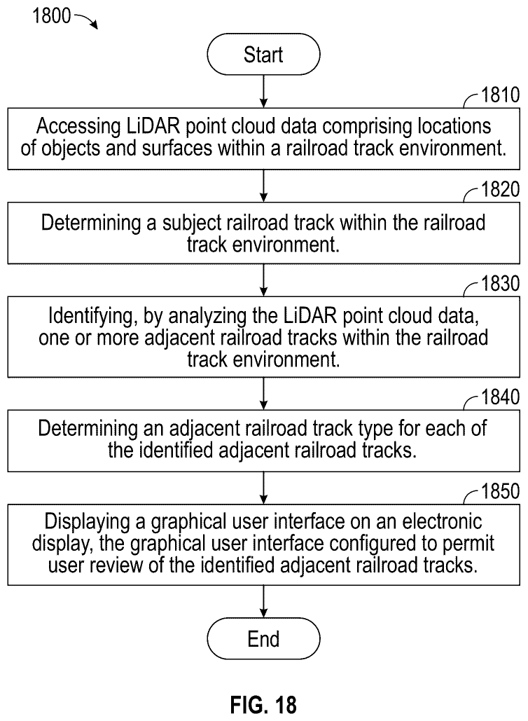

FIG. 18 is a chart illustrating a method 1800 for determining adjacent railroad tracks in a railroad track environment, according to particular embodiments. In some embodiments, method 1800 may be performed by railroad adjacent track detection module 124 of railroad oversized load clearance system 100. At step 1810, method 1800 accesses LiDAR point cloud data stored in one or more memory units. In some embodiments, the LiDAR point cloud data includes locations of objects and surfaces within a railroad track environment. In some embodiments, the LiDAR point cloud data is LiDAR point cloud data 155. In some embodiments, the LiDAR point cloud data 155 is generated by one or more LiDAR instruments attached to a rail vehicle.

At step 1820, method 1800 determines, by analyzing the LiDAR point cloud data of step 1810, a subject railroad track within the railroad track environment. In some embodiments, the subject railroad track is subject railroad track 1500. In some embodiments, step 1820 includes generating a cross-section of the LiDAR point cloud data at a particular track centerline point such as track centerline point 322. Method 1800 may then determine, by analyzing the cross-section of the LiDAR point cloud data, rails of a railroad track as described in reference to top-of-rails module 310. In some embodiments, the determined rails are identified rails 311. Step 1820 may additionally include determining the subject railroad track by selecting two of the determined rails that are a predetermined distance from the track centerline point. In some embodiments, the predetermined distance is half of the standard gauge of the railroad track.

At step 1830, method 1800 identifies, by analyzing the LiDAR point cloud data, one or more adjacent railroad tracks within the railroad track environment. Each adjacent railroad track is adjacent to the subject railroad track determined in step 1820. In some embodiments, step 1830 is performed by adjacent track generation module 1510. In some embodiments, the one or more adjacent railroad tracks are adjacent tracks 1511. In some embodiments, step 1830 includes analyzing the cross-section of step 1820 in order to pair two adjacent identified rails together as an adjacent railroad track based on distances between the adjacent identified rails. In some embodiments, the distances between the adjacent identified rails are compared to the standard gauge of a railroad track.

At step 1840, method 1800 determines an adjacent railroad track type for each of the identified one or more adjacent railroad tracks of step 1830. In some embodiments, step 1840 is performed by adjacent track processing module 1520. In some embodiments, step 1840 includes comparing location information of each identified adjacent railroad track to a GIS database. In some embodiments, step 1840 includes measuring a distance between a track centerline of the subject railroad track and a track centerline of each identified adjacent railroad track.

At step 1850, method 1800 displays a graphical user interface on an electronic display. In some embodiments, the graphical user interface is graphical user interface 1700 that is displayed on client system 130. In some embodiments, the graphical user interface is configured to permit user review of the one or more adjacent railroad tracks of step 1830. In some embodiments, the graphical user interface is configured to display the determined adjacent track type (e.g., adjacent track type 1521) for each particular identified adjacent railroad track and one or more images of the particular identified adjacent railroad track. In some embodiments, the one or more images of the particular identified adjacent railroad track includes a cropped portion of the LiDAR point cloud data (e.g., cropped point cloud 1512) that includes the particular identified adjacent railroad track. In some embodiments, the one or more images of the particular identified adjacent railroad track comprises a cropped image of one of a plurality of 360-degree images captured by a 360-degree camera attached to a rail vehicle. After step 1850, method 1800 may end.

In some embodiments, method 1800 additionally includes determining that a particular train route is devoid of any identified adjacent railroad tracks and electronically transmitting a clearance signal to a train or another system. In some embodiments, the clearance signal indicates that the particular train route is devoid of any identified adjacent railroad tracks. In some embodiments, the clearance signal is oversized load clearance signal 102.

Particular embodiments may repeat one or more steps of the method of FIG. 18, where appropriate. Although this disclosure describes and illustrates particular steps of the method of FIG. 18 as occurring in a particular order, this disclosure contemplates any suitable steps of the method of FIG. 18 occurring in any suitable order. Moreover, although this disclosure describes and illustrates an example method including the particular steps of the method of FIG. 18, this disclosure contemplates any suitable method including any suitable steps, which may include all, some, or none of the steps of the method of FIG. 18, where appropriate. Furthermore, although this disclosure describes and illustrates particular components, devices, or systems carrying out particular steps of the method of FIG. 18, this disclosure contemplates any suitable combination of any suitable components, devices, or systems carrying out any suitable steps of the method of FIG. 18.

FIG. 19 illustrates an example computer system 1900 that can be utilized to implement aspects of the various methods and systems presented herein, according to particular embodiments. In particular embodiments, one or more computer systems 1900 perform one or more steps of one or more methods described or illustrated herein. In particular embodiments, one or more computer systems 1900 provide functionality described or illustrated herein. In particular embodiments, software running on one or more computer systems 1900 performs one or more steps of one or more methods described or illustrated herein or provides functionality described or illustrated herein. Particular embodiments include one or more portions of one or more computer systems 1900. Herein, reference to a computer system may encompass a computing device, and vice versa, where appropriate. Moreover, reference to a computer system may encompass one or more computer systems, where appropriate.

This disclosure contemplates any suitable number of computer systems 1900. This disclosure contemplates computer system 1900 taking any suitable physical form. As example and not by way of limitation, computer system 1900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1900 may include one or more computer systems 1900; be unitary or distributed; span multiple locations; span multiple machines; span multiple data centers; or reside in a cloud, which may include one or more cloud components in one or more networks. Where appropriate, one or more computer systems 1900 may perform without substantial spatial or temporal limitation one or more steps of one or more methods described or illustrated herein. As an example, and not by way of limitation, one or more computer systems 1900 may perform in real time or in batch mode one or more steps of one or more methods described or illustrated herein. One or more computer systems 1900 may perform at different times or at different locations one or more steps of one or more methods described or illustrated herein, where appropriate.

In particular embodiments, computer system 1900 includes a processor 1902, memory 1904, storage 1906, an input/output (I/O) interface 1908, a communication interface 1910, and a bus 1912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1902 includes hardware for executing instructions, such as those making up a computer program. As an example, and not by way of limitation, to execute instructions, processor 1902 may retrieve (or fetch) the instructions from an internal register, an internal cache, memory 1904, or storage 1906; decode and execute them; and then write one or more results to an internal register, an internal cache, memory 1904, or storage 1906. In particular embodiments, processor 1902 may include one or more internal caches for data, instructions, or addresses. This disclosure contemplates processor 1902 including any suitable number of any suitable internal caches, where appropriate. As an example, and not by way of limitation, processor 1902 may include one or more instruction caches, one or more data caches, and one or more translation lookaside buffers (TLBs). Instructions in the instruction caches may be copies of instructions in memory 1904 or storage 1906, and the instruction caches may speed up retrieval of those instructions by processor 1902. Data in the data caches may be copies of data in memory 1904 or storage 1906 for instructions executing at processor 1902 to operate on; the results of previous instructions executed at processor 1902 for access by subsequent instructions executing at processor 1902 or for writing to memory 1904 or storage 1906; or other suitable data. The data caches may speed up read or write operations by processor 1902. The TLBs may speed up virtual-address translation for processor 1902. In particular embodiments, processor 1902 may include one or more internal registers for data, instructions, or addresses. This disclosure contemplates processor 1902 including any suitable number of any suitable internal registers, where appropriate. Where appropriate, processor 1902 may include one or more arithmetic logic units (ALUs); be a multi-core processor; or include one or more processors 1902. Although this disclosure describes and illustrates a particular processor, this disclosure contemplates any suitable processor.

In particular embodiments, memory 1904 includes main memory for storing instructions for processor 1902 to execute or data for processor 1902 to operate on. As an example, and not by way of limitation, computer system 1900 may load instructions from storage 1906 or another source (such as, for example, another computer system 1900) to memory 1904. Processor 1902 may then load the instructions from memory 1904 to an internal register or internal cache. To execute the instructions, processor 1902 may retrieve the instructions from the internal register or internal cache and decode them. During or after execution of the instructions, processor 1902 may write one or more results (which may be intermediate or final results) to the internal register or internal cache. Processor 1902 may then write one or more of those results to memory 1904. In particular embodiments, processor 1902 executes only instructions in one or more internal registers or internal caches or in memory 1904 (as opposed to storage 1906 or elsewhere) and operates only on data in one or more internal registers or internal caches or in memory 1904 (as opposed to storage 1906 or elsewhere). One or more memory buses (which may each include an address bus and a data bus) may couple processor 1902 to memory 1904. Bus 1912 may include one or more memory buses, as described below. In particular embodiments, one or more memory management units (MMUs) reside between processor 1902 and memory 1904 and facilitate accesses to memory 1904 requested by processor 1902. In particular embodiments, memory 1904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1904 may include one or more memories 1904, where appropriate. Although this disclosure describes and illustrates particular memory, this disclosure contemplates any suitable memory.

In particular embodiments, storage 1906 includes mass storage for data or instructions. As an example, and not by way of limitation, storage 1906 may include a hard disk drive (HDD), a floppy disk drive, flash memory, an optical disc, a magneto-optical disc, magnetic tape, or a Universal Serial Bus (USB) drive or a combination of two or more of these. Storage 1906 may include removable or non-removable (or fixed) media, where appropriate. Storage 1906 may be internal or external to computer system 1900, where appropriate. In particular embodiments, storage 1906 is non-volatile, solid-state memory. In particular embodiments, storage 1906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1906 taking any suitable physical form. Storage 1906 may include one or more storage control units facilitating communication between processor 1902 and storage 1906, where appropriate. Where appropriate, storage 1906 may include one or more storages 1906. Although this disclosure describes and illustrates particular storage, this disclosure contemplates any suitable storage.

In particular embodiments, I/O interface 1908 includes hardware, software, or both, providing one or more interfaces for communication between computer system 1900 and one or more I/O devices. Computer system 1900 may include one or more of these I/O devices, where appropriate. One or more of these I/O devices may enable communication between a person and computer system 1900. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1908 for them. Where appropriate, I/O interface 1908 may include one or more device or software drivers enabling processor 1902 to drive one or more of these I/O devices. I/O interface 1908 may include one or more I/O interfaces 1908, where appropriate. Although this disclosure describes and illustrates a particular I/O interface, this disclosure contemplates any suitable I/O interface.

In particular embodiments, communication interface 1910 includes hardware, software, or both providing one or more interfaces for communication (such as, for example, packet-based communication) between computer system 1900 and one or more other computer systems 1900 or one or more networks. As an example, and not by way of limitation, communication interface 1910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1910 for it. As an example, and not by way of limitation, computer system 1900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 1900 may include any suitable communication interface 1910 for any of these networks, where appropriate. Communication interface 1910 may include one or more communication interfaces 1910, where appropriate. Although this disclosure describes and illustrates a particular communication interface, this disclosure contemplates any suitable communication interface.

In particular embodiments, bus 1912 includes hardware, software, or both coupling components of computer system 1900 to each other. As an example and not by way of limitation, bus 1912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1912 may include one or more buses 1912, where appropriate. Although this disclosure describes and illustrates a particular bus, this disclosure contemplates any suitable bus or interconnect.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in the included FIGURES may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system for determining adjacent railroad tracks in a railroad track environment using light detection and ranging (LiDAR), the system comprising:
one or more LiDAR instruments configured to capture LiDAR point cloud data comprising locations of objects and surfaces within the railroad track environment;
one or more memory units configured to store the LiDAR point cloud data; and
one or more computer processors communicatively coupled to the one or more memory units and configured to:
access the LiDAR point cloud data stored in the one or more memory units;
determine, by analyzing the LiDAR point cloud data, a subject railroad track within the railroad track environment;
identify, by analyzing the LiDAR point cloud data, one or more adjacent railroad tracks within the railroad track environment, each adjacent railroad track being adjacent to the subject railroad track;
determine, from a plurality of adjacent railroad track types, an adjacent railroad track type for each of the identified adjacent railroad tracks; and
display a graphical user interface on an electronic display, the graphical user interface configured to permit user review of the identified adjacent railroad tracks, the graphical user interface configured to display for each particular identified adjacent railroad track:
the determined adjacent railroad track type for the particular identified adjacent railroad track; and
one or more images of the particular adjacent railroad track.

2. The system of claim 1, further comprising a 360-degree camera configured to capture a plurality of 360-degree images of the railroad track environment, wherein the one or more images of the particular adjacent railroad track comprises a cropped image of one of the plurality of 360-degree images captured by the 360-degree camera.

3. The system of claim 1, wherein the one or more images of the particular adjacent railroad track comprises a cropped portion of the LiDAR point cloud data that includes the particular adjacent railroad track.

4. The system of claim 1, wherein the plurality of adjacent railroad track types comprises:
a cross-over track; and
a close-track-center track.

5. The system of claim 1, the one or more computer processors further configured to:
determine that a particular train route is devoid of any identified adjacent railroad tracks; and
electronically transmit a clearance signal to a train or another system, the clearance signal indicating that the particular train route is devoid of any identified adjacent railroad tracks.

6. The system of claim 1, wherein identifying, by analyzing the LiDAR point cloud data, one or more adjacent railroad tracks within the railroad track environment comprises:
generating a cross-section of the LiDAR point cloud data;
identifying, from the generated cross-section, a plurality of railroad track rails; and
pairing the identified railroad track rails together based on determined distances between the identified railroad track rails.

7. The system of claim 1, wherein determining the obstruction type for each of the identified plurality of obstructions comprises:
determining a location associated with each particular identified obstruction; and
cross-referencing the determined location associated with the particular identified obstruction with a geographic information system (GIS) database.

8. A method by a computing system for determining adjacent railroad tracks in a railroad track environment using light detection and ranging (LiDAR), the method comprising:
accessing LiDAR point cloud data stored in one or more memory units, the LiDAR point cloud data comprising locations of objects and surfaces within the railroad track environment;
determining, by analyzing the LiDAR point cloud data, a subject railroad track within the railroad track environment;
identifying, by analyzing the LiDAR point cloud data, one or more adjacent railroad tracks within the railroad track environment, each adjacent railroad track being adjacent to the subject railroad track;
determining, from a plurality of adjacent railroad track types, an adjacent railroad track type for each of the identified adjacent railroad tracks; and
displaying a graphical user interface on an electronic display, the graphical user interface configured to permit user review of the identified adjacent railroad tracks, the graphical user interface configured to display for each particular identified adjacent railroad track:
the determined adjacent railroad track type for the particular identified adjacent railroad track; and
one or more images of the particular adjacent railroad track.

9. The method of claim 8, wherein the one or more images of the particular adjacent railroad track comprises a cropped image of one of a plurality of 360-degree images captured by a 360-degree camera.

10. The method of claim 8, wherein the one or more images of the particular adjacent railroad track comprises a cropped portion of the LiDAR point cloud data that includes the particular adjacent railroad track.

11. The method of claim 8, wherein the plurality of adjacent railroad track types comprises:
a cross-over track; and
a close-track-center track.

12. The method of claim 8, further comprising:
determining that a particular train route is devoid of any identified adjacent railroad tracks; and
electronically transmitting a clearance signal to a train or another system, the clearance signal indicating that the particular train route is devoid of any identified adjacent railroad tracks.

13. The method of claim 8, wherein identifying, by analyzing the LiDAR point cloud data, one or more adjacent railroad tracks within the railroad track environment comprises:
generating a cross-section of the LiDAR point cloud data;
identifying, from the generated cross-section, a plurality of railroad track rails; and
pairing the identified railroad track rails together based on determined distances between the identified railroad track rails.

14. The method of claim 8, wherein determining the obstruction type for each of the identified plurality of obstructions comprises:
determining a location associated with each particular identified obstruction; and
cross-referencing the determined location associated with the particular identified obstruction with a geographic information system (GIS) database.

15. One or more computer-readable non-transitory storage media embodying instructions that, when executed by a processor, cause the processor to perform operations comprising:
accessing light detection and ranging (LiDAR) point cloud data stored in one or more memory units, the LiDAR point cloud data comprising locations of objects and surfaces within a railroad track environment;
identifying, by analyzing the LiDAR point cloud data, one or more adjacent railroad tracks within the railroad track environment, each adjacent railroad track being adjacent to a subject railroad track;
determining, from a plurality of adjacent railroad track types, an adjacent railroad track type for each of the identified adjacent railroad tracks; and
displaying a graphical user interface on an electronic display, the graphical user interface configured to permit user review of the identified adjacent railroad tracks, the graphical user interface configured to display for each particular identified adjacent railroad track:
the determined adjacent railroad track type for the particular identified adjacent railroad track; and
one or more images of the particular adjacent railroad track.

16. The one or more computer-readable non-transitory storage media of claim 15, wherein the one or more images of the particular adjacent railroad track comprises a cropped image of one of a plurality of 360-degree images captured by a 360-degree camera.

17. The one or more computer-readable non-transitory storage media of claim 15, wherein the one or more images of the particular adjacent railroad track comprises a cropped portion of the LiDAR point cloud data that includes the particular adjacent railroad track.

18. The one or more computer-readable non-transitory storage media of claim 15, the operations further comprising:
determining that a particular train route is devoid of any identified adjacent railroad tracks; and
electronically transmitting a clearance signal to a train or another system, the clearance signal indicating that the particular train route is devoid of any identified adjacent railroad tracks.

19. The one or more computer-readable non-transitory storage media of claim 15, wherein identifying, by analyzing the LiDAR point cloud data, one or more adjacent railroad tracks within the railroad track environment comprises:
generating a cross-section of the LiDAR point cloud data;
identifying, from the generated cross-section, a plurality of railroad track rails; and
pairing the identified railroad track rails together based on determined distances between the identified railroad track rails.

20. The one or more computer-readable non-transitory storage media of claim 15, wherein determining the obstruction type for each of the identified plurality of obstructions comprises:
determining a location associated with each particular identified obstruction; and
cross-referencing the determined location associated with the particular identified obstruction with a geographic information system (GIS) database.
